(19) United States
(12) Patent Application Publication
(10) Pub. No.: US 2024/0383201 A1
(43) Pub. Date: Nov. 21, 2024

(54) STATIC MIXING NOZZLES FOR FIBER RANDOMIZATION IN LARGE SCALE ADDITIVE MANUFACTURING APPLICATIONS

(71) Applicant: UT-Battelle, LLC, Oak Ridge, TN (US)

(72) Inventors: Tyler C. Smith, Knoxville, TN (US); Ahmed A. Hassen, Knoxville, TN (US); John M. Lindahl, Powell, TN (US); Seokpum Kim, Knoxville, TN (US); Vlastimil Kunc, Knoxville, TN (US); Vipin Kumar, Knoxville, TN (US); Brian K. Post, Knoxville, TN (US); Peeyush Nandwana, Knoxville, TN (US)

(21) Appl. No.: 18/375,085

(22) Filed: Sep. 29, 2023

Related U.S. Application Data
(60) Provisional application No. 63/467,607, filed on May 19, 2023.
(60) Provisional application No. 63/467,606, filed on May 19, 2023.

(51) Int. Cl. B29C 64/314; B29B 7/32; B29C 64/336

(52) U.S. Cl. CPC B29C 64/314; B29B 7/325; B29C 64/336; B33Y 10/00; B33Y 30/00; B33Y 40/10

(57) ABSTRACT

An additive manufacturing system for additive manufacturing with an additive manufacturing material and fibers includes an extruder comprising a static-mixing nozzle having a static-mixing channel and static-mixing structures distributed inside the static-mixing channel and extending radially inward from the channel wall, and being longitudinally distributed and radially staggered over a portion of the length of the static-mixing channel. A static-mixing nozzle, a method of additive manufacturing, and a method of making a static mixing nozzle for additive manufacturing are also disclosed.

### CROSS-REFERENCE TO RELATED APPLICATIONS

This application claims priority to U.S. Provisional Patent Application No. 63/467,606 filed on May 19, 2023, titled “STATIC MIXING NOZZLES FOR LONG FIBER AND RESIN MIXING AND DISPERSING IN POLYMER ADDITIVE MANUFACTURING”, and U.S. Provisional Patent Application No. 63/467,607 filed May 19, 2023, titled “STATIC MIXING NOZZLES FOR FIBER RANDOMIZATION IN LARGE SCALE ADDITIVE MANUFACTURING APPLICATIONS” the entire disclosures of which are incorporated herein by reference. This application is related to U.S. Utility patent application Ser. No. 18/375,019 titled “STATIC MIXING NOZZLES FOR LONG FIBER AND RESIN MIXING AND DISPERSING IN POLYMER ADDITIVE MANUFACTURING” and U.S. Utility patent application Ser. No. 18/375,053 titled “HIGHLY ALIGNED FIBER NOZZLE FOR ADDITIVE MANUFACTURING APPLICATIONS”, both filed on even date herewith, the entire disclosures of which are hereby fully incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates generally to additive manufacturing, and more particularly to nozzles for extruders used in additive manufacturing with additive manufacturing materials incorporating fibers.

### BACKGROUND OF THE INVENTION

Also known as 3D printing, additive manufacturing has been one of the fastest growing fields with instruments capable of processing metals, ceramics, and polymers. While each additive manufacturing platform requires a particular material form, from photosensitive liquids to micron-sized powders, the additive manufacturing techniques provide the ability to produce complex geometries that are difficult to manufacture with conventional methods. Polymer additive manufacturing platforms can use thermoplastic or thermoset materials and are generally classified as direct write (DW), material jetting (MJ), Fused Filament Fabrication (FFF), and material extrusion (ME).

Recent advancements in polymer additive manufacturing have largely been driven by extruding fiber-reinforced composite materials. The inclusion of carbon fiber in thermoplastic extrusion is crucial for limiting the impacts of warping and residual stresses. Additionally, carbon fiber and other compositing materials enable thermoplastic additive manufacturing to compete with conventional thermoset manufacturing. While these advancements have been important steps in the development of additive manufacturing techniques, a more recent area of focus has been multi-material construction. Seamless inclusion of multi-material construction in additive manufacturing allows for multi-purpose construction much better suited to end-use production.

There are many methods of incorporating more than one material in additive manufacturing (AM) processes. Dual-hopper feed systems are known that enable in-situ material switching during big area additive manufacturing (BAAM) processes. Continuous extrusion during a step-change in material feedstock results in a unique blended material transition region that exhibits a heterogeneous internal morphology.

Large scale additive manufacturing is conducted by melting thermoplastic polymers through a single screw extruder to produce a part in a layer-by-layer process. Non-filled polymers tend to have issues such as cracking, warping, and lower stiffness and lead to part failures. As such, short-chopped fibers are added to stiffen the material to prevent failure both during and after the print while also significantly increasing the mechanical stiffness and strength. During extrusion, however, the fibers tend to align in the direction of the deposition from shear in the nozzle which leads to parts with highly anisotropic properties. The printed beads have highly aligned fibers, along the extrusion direction, at the outer perimeters of the bead, called a skin, while the core of the bead has less fiber orientation. The size of the skin and the core zones are highly dependent on the size of the nozzle.

The printed part will exhibit low coefficient of linear thermal expansion (CLTE), high stiffness, high strength and thermal properties in the print direction while the other two directions experience lower mechanical properties with higher CLTE properties. CLTE is a critical material property that should be considered during the design phase for applications such as tooling, one of the most highlighted applications for large scale additive manufacturing technology. In tooling applications an isotropic CLTE is highly desired as it allows for easy modeling of growth and shrinkage of the tool during the heat up and cool down ramps. This will lead to fabrication of composite parts with desired tolerances. When CLTE values significantly differ, modeling of shrinkage becomes complex and difficult to measure and will lead to mismatches between design-part tolerances and actual fabricated-part tolerances.

### SUMMARY OF THE INVENTION

An additive manufacturing system includes an extruder with a static-mixing nozzle having a static-mixing channel defined by a channel wall. The static-mixing channel has a diameter D_{SMC} and a longitudinal center axis having length L_{SMC}, an input end and an opposing output end. The static-mixing channel can be fluidly coupled at the input end to feeding means through which additive manufacturing material and short-chopped fiber are to be provided to the extruder. The static-mixing nozzle includes static-mixing structures distributed inside the static-mixing channel and extending radially inward from the channel wall. The static-mixing structures having a length L_{MS}, a width W_{MS} and a radial dimension R_{MS}, and are longitudinally distributed and radially staggered over a portion of the length of L_{SMC} of the static-mixing channel.

The static-mixing nozzle is configured to guide a bead of the additive manufacturing material and short-chopped fiber from the input end to the output end of the static-mixing channel, mix the short-chopped fiber with the additive manufacturing material to randomize orientations of the short-chopped fiber within the additive manufacturing material, and extrude a bead of mixed additive manufacturing material and short-chopped fiber through the output end. An extruded bead can be deposited as part of a layer of an object being formed by the additive manufacturing system.

The static-mixing structures can extend from and can be connected to one position on the channel wall to another position on the channel wall. The static-mixing structures can be rods, and spaces between the rods defining flow openings for the additive manufacturing material and the short-chopped fiber. The diameter of the rods D_{R} can be from 1 to 30% D_{FC}. The static-mixing structures can be grids having planar portions and a plurality of flow openings. The diameter of the flow openings D_{FO} can be from 1 to 50% of D_{SMC}. The static-mixing structures can be connected from an upstream position on the channel wall to a downstream position of the channel wall.

The bead can have a skin comprising aligned short chop fibers. The skin has a radial thickness T_{SK}. and the radial dimension of the static-mixing structures R_{MS} can be a least as great as the skin thickness T_{SK}. The radial dimension of the static-mixing structures R_{MS} can be less than ½ D_{SMC}, and the circumferential width is less than ¼ of a circumference of the static-mixing channel. The diameter of a central core D_{CC} is defined by D_{SMC}−2 RMs, and D_{CC} can be from 10% to 50% of D_{FC}. The radial dimension R_{MS} of the static-mixing structures can be greater than 0.2 T_{SK}.

The static-mixing structures can be semispherical in shape. The static-mixing structures can be tooth shaped. The static-mixing structures can be longitudinally staggered and radially distributed in a helical pattern. The static-mixing structures can be longitudinally staggered and radially distributed in a double helical pattern.

The short-chopped fibers can have a length of from 0.1 mm to 12 mm. The short-chopped fiber can be at least one selected from the group consisting of C fiber, glass fiber, or bio fiber. The system of claim 1, wherein the short-chopped fiber has an aspect ratio s=L/d less than 100, L being the fiber's length and d being the fiber's diameter.

The additive manufacturing material can be any of several possible materials. The additive manufacturing material can be a thermoplastic polymer.

The static mixing channel can have any of several possible shapes. The static-mixing channel can be tubular.

A static mixing nozzle for an additive manufacturing system includes a static-mixing channel defined by a channel wall. The static-mixing channel has a diameter D_{SMC}, and a longitudinal center axis having length L_{SMC}, an input end and an opposing output end. The static-mixing channel can be fluidly coupled at the input end to feeding means through which additive manufacturing material and short-chopped fiber are to be provided to the extruder. The static-mixing nozzle includes static-mixing structures distributed inside the static-mixing channel and extending radially inward from the channel wall. The static-mixing structures have a radial length L_{MS}, a width W_{MS} and a radial dimension R_{MS}, being longitudinally distributed and radially staggered over a portion of the length of L_{SMC} of the static-mixing channel.

The static-mixing nozzle is configured to guide a bead of the provided thermoplastic resin and short-chopped fiber from the input end to the output end of the static-mixing channel, mix the short-chopped fiber with the thermoplastic resin to randomize orientations of the short-chopped fiber within the thermoplastic resin, and extrude a bead of mixed thermoplastic resin and short-chopped fiber through the output end. An extruded bead is deposited as part of a layer of an object being formed by the additive manufacturing system.

A method for additive manufacturing with additive manufacturing material and short-chopped fibers includes the step of providing an extruder comprising a static-mixing nozzle having a static-mixing channel defined by a channel wall, the static-mixing channel having a diameter D_{SMC}, and a longitudinal center axis having length L_{SMC}, an input end and an opposing output end. The static-mixing channel can be fluidly coupled at the input end to feeding means through which the additive manufacturing material and short-chopped fiber are to be provided to the extruder. The static-mixing nozzle includes static-mixing structures distributed inside the static-mixing channel and extending radially inward from the channel wall. The static-mixing structures have a radial length L_{MS}, a width W_{MS} and a radial dimension R_{MS}, being longitudinally distributed and radially staggered over a portion of the length of L_{SMC} of the static-mixing channel.

A bead of the provided additive manufacturing material and short-chopped fiber is guided from the input end to the output end of the static-mixing channel. The short-chopped fiber is mixed with the additive manufacturing material by contact with the static-mixing structures to randomize orientations of the short-chopped fiber within the additive manufacturing material. A bead of mixed additive manufacturing material and short-chopped fiber is extruded through the output end, causing the extruded bead to be deposited as part of a layer of an object being formed by the additive manufacturing system.

A method of making a nozzle for the additive manufacturing of polymer and composite materials with short-chopped fibers includes the step of providing a nozzle having a central channel and flowing an additive manufacturing material and short-chopped fiber through the nozzle and drawing an extruded bead of the additive manufacturing material and short-chopped fiber. The bead has a core of additive manufacturing material and randomized short-chopped fibers. The core has a diameter D_{CC}, and a skin comprising aligned short chop fibers, wherein the skin has a radial thickness T_{SK}. The T_{SK} is measured.

A static-mixing nozzle is constructed having a static-mixing channel defined by a channel wall. The static-mixing channel has a diameter D_{SMC}, a length L_{SMC}, a longitudinal center axis A_{SMC} an input end and an opposing output end. The static-mixing channel can be fluidly coupled at the input end to feeding means through which the additive manufacturing material and short-chopped fiber are to be provided to the extruder. The static-mixing nozzle includes static-mixing structures distributed inside the static-mixing channel and extending radially inward from the channel wall. The static-mixing structures have a radial length L_{MS}, a width W_{MS} and a radial dimension R_{MS}, and are longitudinally distributed and radially staggered over a portion of the length L_{SMC} of the static-mixing channel. The radial dimension of the static-mixing structures R_{MS} is a least 0.2 T_{SK}.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a bottom perspective view of a nozzle according to the invention with toothed static-mixing structures.

FIG. 2 is a top perspective view.

FIG. 3 is a front elevation.

FIG. 4 is a side elevation.

FIG. 5 is a bottom view.

FIG. 6 is a top plan view.

FIG. 7 is a cross-section taken along line 7-7 in FIG. 5.

FIG. 8 is a cross-section taken along line 8-8 in FIG. 5.

FIG. 9 is a bottom perspective view, partially in phantom.

FIG. 10 is a side perspective view, partially in phantom.

FIG. 11 is an expanded view of area FIG. 11 in FIG. 10.

FIG. 12 is a schematic depiction of a double helical arrangement of static-mixing structures.

FIG. 13 is a side elevation, partially in phantom.

FIG. 14 is an expanded view of area FIG. 14 in FIG. 10, partially in phantom and in operation.

FIG. 15 is a cross-section of the static-mixing channel in operation.

FIG. 16 is a cross-section of a portion of an additive manufacturing nozzle without static-mixing structures, and in operation.

FIG. 17 is a bottom perspective view of a static-mixing nozzle embodiment with semispherical static-mixing structures.

FIG. 18 is a top perspective view.

FIG. 19 is a side perspective view, partially in phantom.

FIG. 20 is a side elevation.

FIG. 21 is a bottom view.

FIG. 22 is a top plan view.

FIG. 23 is a cross-section taken along line 23-23 in FIG. 21.

FIG. 24 is a cross-section taken along line 24-24 in FIG. 21.

FIG. 25 is a side perspective view, partially in phantom, of a static-mixing nozzle embodiment with toothed and semispherical static mixing structures.

FIG. 26 is an expanded view of area FIG. 26 in FIG. 25.

FIG. 27 is a bottom perspective view of a static-mixing nozzle embodiment with grid static-mixing structures.

FIG. 28 is a front elevation.

FIG. 29 is a side elevation.

FIG. 30 is a bottom view.

FIG. 31 is a top plan view.

FIG. 32 is a cross-section taken along line 32-32 in FIG. 30.

FIG. 33 is a cross-section taken along line 33-33 in FIG. 31.

FIG. 34 is a side perspective view, partially in phantom.

FIG. 35 is an expanded view of area FIG. 35 in FIG. 34.

FIG. 36 is a front elevation of an alternative embodiment of a static-mixing nozzle with rods as static-mixing structures.

FIG. 37 is a bottom view.

FIG. 38 is a top plan view.

FIG. 39 is a cross-section taken along line 39-39 in FIG. 37.

FIG. 40 is a cross-section taken along line 40-40 in FIG. 37.

FIG. 41 is a perspective view of the cross section of FIG. 40.

FIG. 42 is a schematic depiction of an extruder system according to the invention.

FIG. 43 is a cross-section of a diverter valve of the extruder system.

FIG. 44 is a graph of Bead Outer Linear CTE via TMA for different static-mixing nozzles.

FIG. 45 is a graph of Bead Inner Linear CTE via TMA for different static-mixing nozzles.

FIG. 46 is a schematic depiction of the deposition pattern for printed material transitions.

FIG. 47 is a plot of carbon fiber (wt. %) vs. fraction of Barrel Free Volume (V_{N}) indicating purge, transition, and steady-state zones.

FIG. 48 is a plot of carbon fiber (wt. %) vs. fraction of Barrel Free Volume (V_{N}) at 300 RPM comparing the use of a static-mixing nozzle with a conventional nozzle.

FIG. 49 is an optical cross section taken at 200× at 300 RPM at point A of FIG. 48 using a conventional printing nozzle and neat ABS.

FIG. 50 is an optical cross section taken at 200× at 300 RPM at point B of FIG. 48 using a static-mixing nozzle and neat ABS.

FIG. 51 is an optical cross section taken at 200× at 300 RPM at point C of FIG. 48 using a conventional printing nozzle and 3.6 wt. % carbon fiber.

FIG. 52 is an optical cross section taken at 200× at 300 RPM at point D with a static-mixing nozzle and 3.6 wt. % carbon fiber.

FIG. 53 is an optical cross section taken at 200× at 300 RPM at point E using a conventional printing nozzle and 12.4 wt. % carbon fiber.

FIG. 54 is an optical cross section taken at 200× at 300 RPM at point F using a static-mixing nozzle and 12.8 wt. % carbon fiber.

FIG. 55 is an expanded view of the optical cross-section of FIG. 53.

FIG. 56 is an expanded view of the optical cross-section of FIG. 54.

FIG. 57 is a grayscale comparison of standard and mixing nozzles.

FIG. 58 is a cross-section from a conventional nozzle with dashes indicating 14.0 mm by 5.1 mm bead dimensions input to BAAM.

FIG. 59 is a cross-section from a static-mixing nozzle with dashes indicating 14.0 mm by 5.1 mm bead dimensions input to BAAM.

FIG. 60 is an optical image taken at 200'3 of polished cross sections from a ABS to CF/ABS 300 RPM transition for a neat ABS specimen from the purge zone.

FIG. 61 is an optical image taken at 200'3 of polished cross sections from a ABS to CF/ABS 300 RPM transition for a transition zone sample with 9.44 wt. % carbon fiber.

### DETAILED DESCRIPTION OF THE INVENTION

An additive manufacturing system includes an extruder including a static-mixing nozzle having a static-mixing channel defined by a channel wall. The static-mixing channel has a diameter D_{SMC} and a longitudinal center axis having length L_{SMC}, an input end and an opposing output end. The static-mixing channel can be fluidly coupled at the input end to feeding means through which additive manufacturing material and short-chopped fiber are to be provided to the extruder. The static-mixing nozzle includes static-mixing structures distributed inside the static-mixing channel which extend radially inward from the channel wall into the static-mixing channel. The static-mixing structures having a length L_{MS}, a width W_{MS} and a radial dimension R_{MS}, and are longitudinally distributed and radially staggered over a portion of the length of L_{SMC} of the static-mixing channel.

The static-mixing nozzle is configured to guide a bead of the additive manufacturing material and short-chopped fiber from the input end to the output end of the static-mixing channel, mix the short-chopped fiber with the additive manufacturing material to randomize orientations of the short-chopped fiber within the additive manufacturing material, and extrude a bead of mixed additive manufacturing material and short-chopped fiber through the output end, causing the extruded bead to be deposited as part of a layer of an object being formed by the additive manufacturing system.

The static-mixing structures can take a variety of different shapes and sizes. The static-mixing structures can be tooth shaped, semispherical, rods, grids and other shapes, The static-mixing structures can extend from and can be connected to one position on the channel wall to another position on the channel wall. The static-mixing structures can be rods, and spaces between the rods defining flow openings for the additive manufacturing material and the short-chopped fiber. The diameter of the rods D_{R} can be from 1 to 30% D_{SMC}. The static-mixing rods can be connected from an upstream position on the channel wall to a downstream position of the channel wall so as to be inclined in the direction of flow. The static-mixing structures can be grids having planar portions and a plurality of flow openings. The diameter of the flow openings D_{FO} can be from 1 to 50% of D_{SMC}. The grid nozzle or rod nozzle are made to forcibly split the polymer melt stream to avoid skins from forming. However, during the bead splitting, internal voids can be created in the bead. The semispherical nozzle addresses the issue by massaging the surface of the bead while leaving a path for material to move such that the bead is never forced to split inside the nozzle preventing further defects.

The bead of additive manufacturing material and short-chopped fibers can form a skin comprising aligned short-chopped fibers. The skin can have a radial thickness T_{SK}, and the radial dimension R_{MS} of the static-mixing structures is a least as great as the skin thickness T_{SK}. The radial dimension of the static-mixing structures R_{MS} can be less than ½ D_{SMC}. The circumferential width of the static-mixing structures W_{MS} can be less than ¼ of a circumference of the static-mixing channel. The diameter of a central core D_{CC} can be defined by D_{FC}−2 R_{MS}, and D_{CC} can be from 10% to 50% of D_{SMC}. The radial dimension RMS of the static-mixing structures can be greater than 0.2 T_{SK}. The longitudinal length of the Lms should be within the range of 1-20% of the longitudinal length of the nozzle.

The static-mixing structures can be distributed about the static-mixing channel in differing distribution densities and patterns. The static-mixing structures can be distributed about the static-mixing channel in a random format, or according to a patterned format. The static-mixing structures can be longitudinally staggered and radially distributed in a helical pattern. The static-mixing structures can be longitudinally staggered and radially distributed in a double helical pattern.

The invention can be used with a variety of differing fiber lengths, diameters, shapes and materials. The short-chopped fibers can have a length of from 0.1 mm to 12 mm. The short-chopped fiber can be at least one of carbon fiber, glass fiber, or various bio fibers. Other fibers are possible. The short-chopped fiber can have an aspect ratio

$$S = \frac{L}{d}$$

less than 100, L being the fiber's length and d being the fiber's diameter.

The invention can be used with a variety of different additive manufacturing materials. The additive manufacturing material can be a thermoplastic polymer. Other additive manufacturing materials are possible such as slurries, thermoset resins, epoxies, and paste.

The static-mixing channel can have varying sizes and shapes. The static-mixing channel can be tubular.

A static-mixing nozzle has a static-mixing channel defined by a channel wall. The static-mixing channel has a diameter D_{SMC} and a length L_{SMC}, longitudinal center axis A_{SMC}, an input end and an opposing output end. The static-mixing channel can be fluidly coupled at the input end to feeding means through which additive manufacturing material and short-chopped fiber are to be provided to the extruder. The static-mixing nozzle includes static-mixing structures distributed inside the static-mixing channel which extend radially inward from the channel wall into the static-mixing channel. The static-mixing structures having a length L_{MS}, a width W_{MS} and a radial dimension R_{MS}, and are longitudinally distributed and radially staggered over a portion of the length of L_{SMC} of the static-mixing channel. The static-mixing nozzle is configured to guide a bead of the additive manufacturing material and short-chopped fiber from the input end to the output end of the static-mixing channel, mix the short-chopped fiber with the additive manufacturing material to randomize orientations of the short-chopped fiber within the additive manufacturing material, and extrude a bead of mixed additive manufacturing material and short-chopped fiber through the output end, causing the extruded bead to be deposited as part of a layer of an object being formed by the additive manufacturing system.

A method for additive manufacturing with additive manufacturing material and short-chopped fibers can include the step of providing an extruder comprising a static-mixing nozzle having a static-mixing channel defined by a channel wall. The static-mixing channel has a diameter D_{SMC}, a length L_{SMC}, and a longitudinal center axis A_{SMC}, an input end and an opposing output end. The static-mixing channel is fluidly coupled at the input end to feeding means through which the additive manufacturing material and short-chopped fiber are to be provided to the extruder. The static-mixing nozzle includes static-mixing structures distributed inside the static-mixing channel and extending radially inward from the channel wall. The static-mixing structures have a radial length L_{MS}, a width W_{MS} and a radial dimension R_{MS}. The static-mixing structures are longitudinally distributed and radially staggered over a portion of the length of L_{SMC} of the static-mixing channel.

A bead of the provided additive manufacturing material and short-chopped fiber is guided from the input end to the output end of the static-mixing channel, and static-mixing the short-chopped fiber with the additive manufacturing material by contact with the static-mixing structures to disperse and randomize the orientations of the short-chopped fiber within the additive manufacturing material. A bead of mixed additive manufacturing material and short-chopped fiber is extruded through the output end, causing the extruded bead to be deposited as part of a layer of an object being formed by the additive manufacturing system.

The static-mixing structures can be optimized for a particular additive manufacturing process. This can be accomplished with a standard nozzle without static-mixing structures, or a test nozzle provided particularly for this purpose, also without static-mixing structures. This nozzle has a central channel. An additive manufacturing material and short-chopped fiber are flowed through the nozzle and an extruded bead of the additive manufacturing material and short-chopped fiber is drawn. The bead has a core of additive manufacturing material and randomized short-chopped fibers. The core has a diameter D_{CC}. A skin is formed by shear force at the wall of the nozzle. The skin short-chopped fibers in the skin are aligned, and the skin having a radial thickness T_{SK}. The T_{SK} is measured.

A static-mixing nozzle is constructed having a static-mixing channel defined by a channel wall. The static-mixing nozzle can be constructed by any suitable method. One such method is additive manufacturing. The static-mixing channel has a diameter D_{SMC}, a length L_{SMC}, a longitudinal center axis A_{SMC}, an input end and an opposing output end. The static-mixing channel can be fluidly coupled at the input end to feeding means through which the additive manufacturing material and short-chopped fiber are to be provided to an extruder. The static-mixing nozzle includes static-mixing structures distributed inside the static-mixing channel which extend radially inward from the channel wall. The static-mixing structures have a radial length L_{MS}, a width W_{MS} and a radial dimension R_{MS}, and are longitudinally distributed and radially staggered over a portion of the length of L_{SMC} of the static-mixing channel. The length of the static-mixing structures L_{MS} is a least 0.2 T_{SK}, where T_{SK} is the skin thickness.

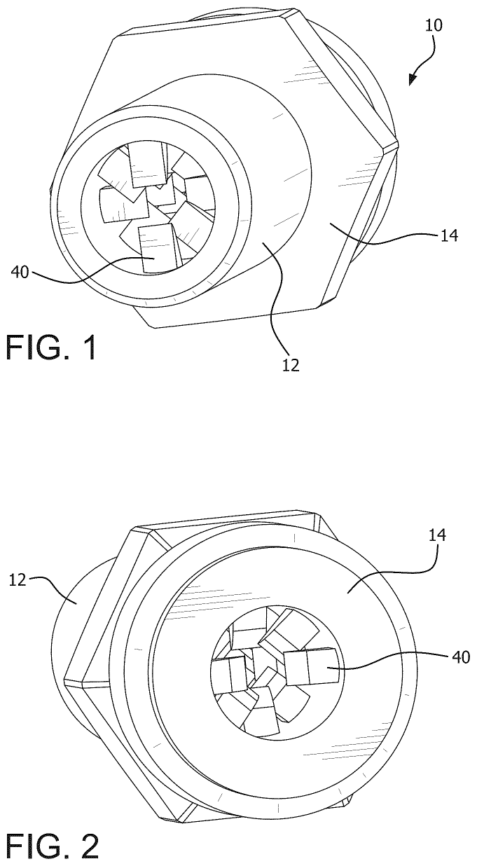

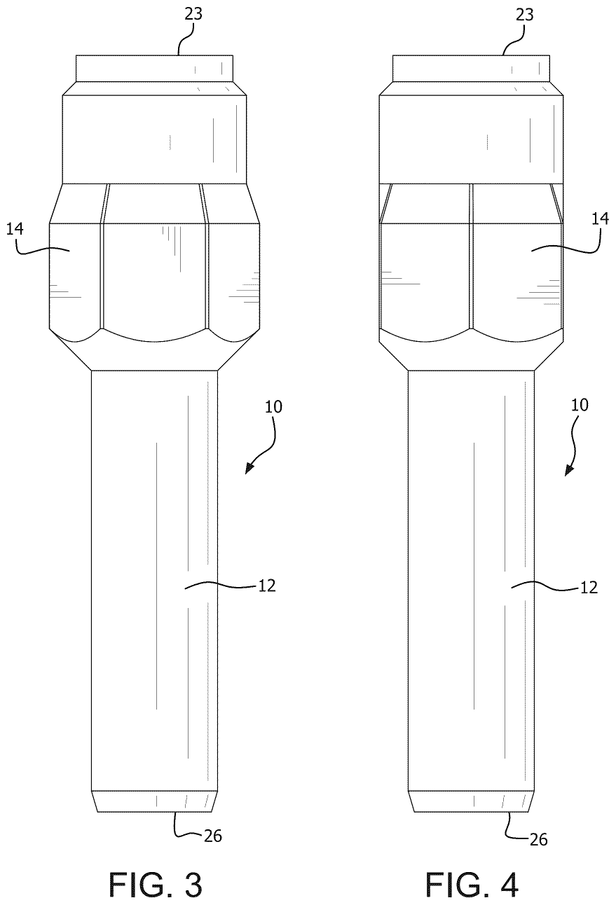

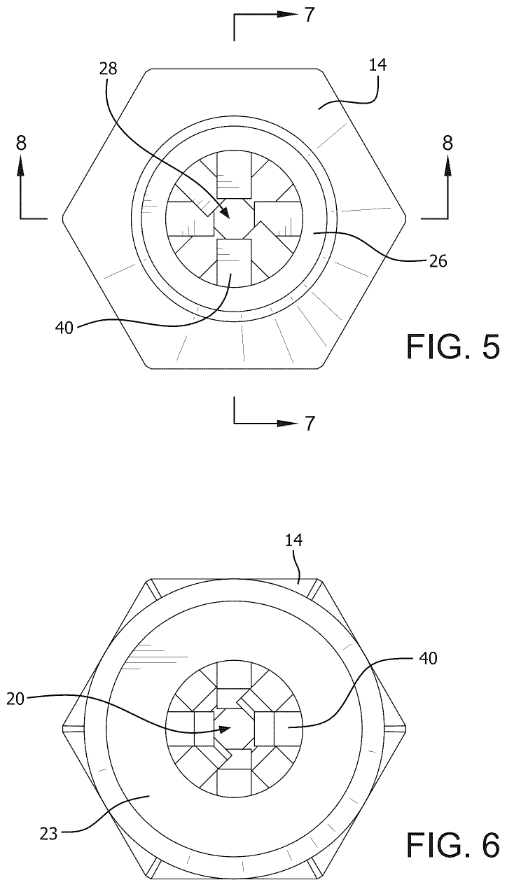

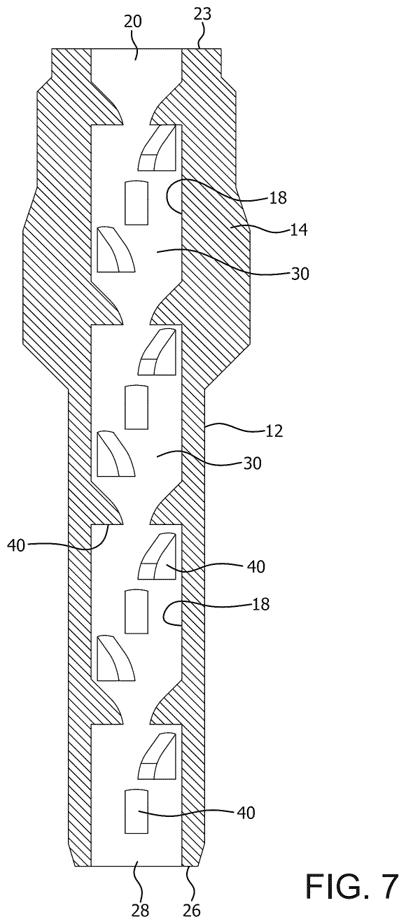

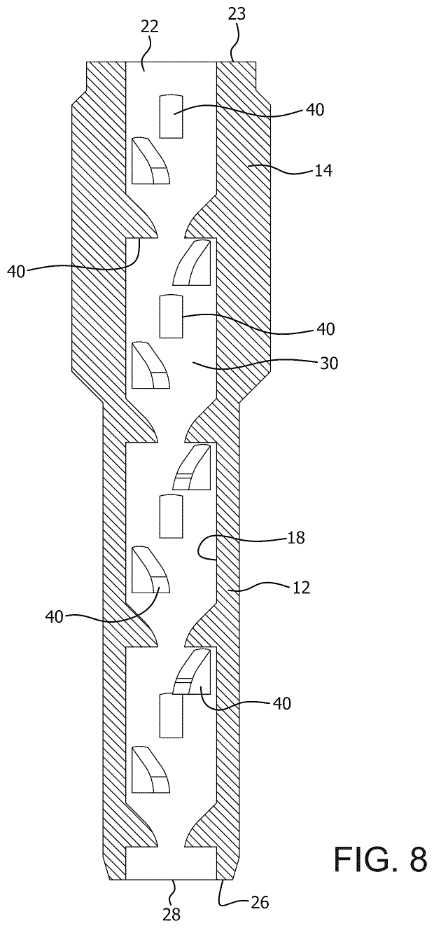

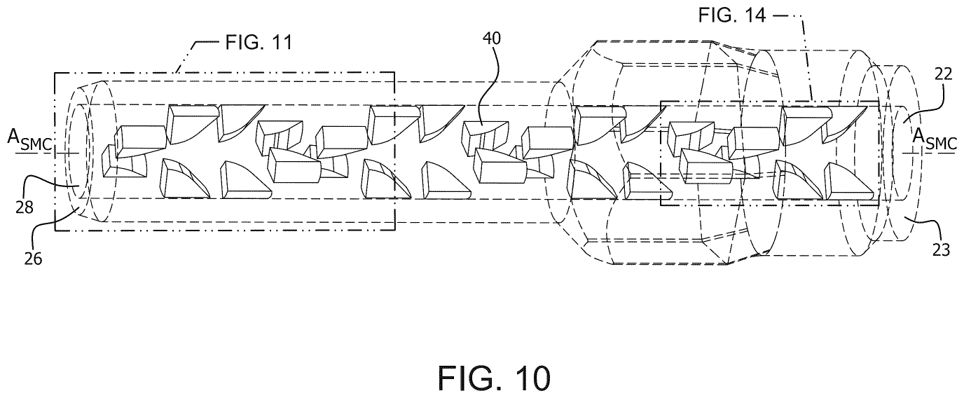

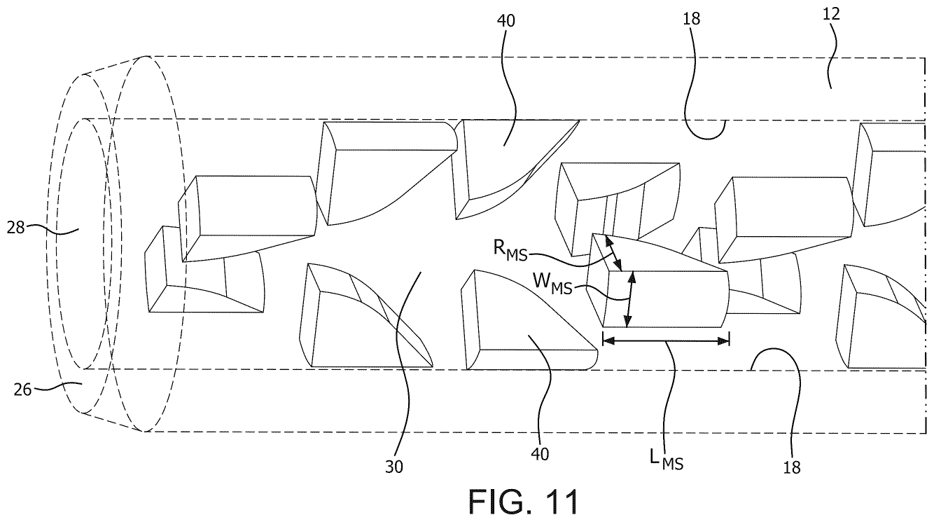

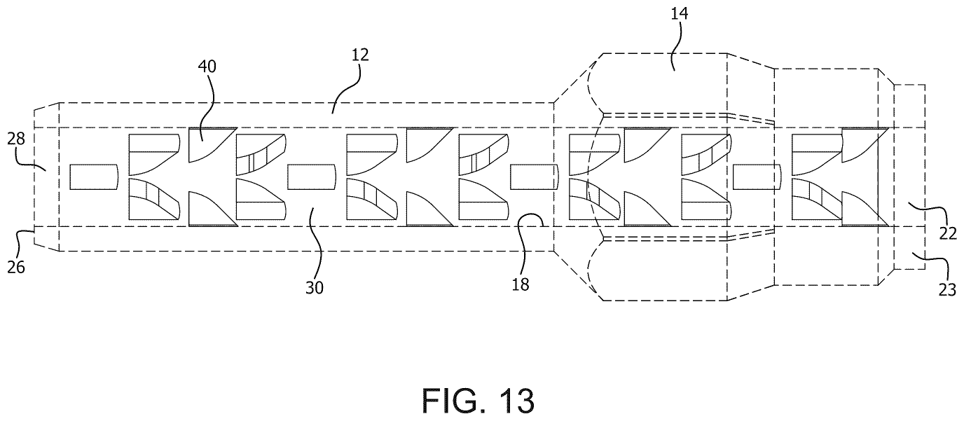

There is shown in FIGS. 1-13 a static mixing nozzle 10 according to the invention. The nozzle 10 includes nozzle body 12 and a nozzle head 14. The nozzle 10 has a proximal end 23 with an additive manufacturing material inlet 20 and a distal end 26 with an additive manufacturing material outlet 28. Nozzle 10 has an interior wall 18 which defines a static-mixing chamber 30. Within the static mixing 30 are a plurality of static-mixing structures 40. The static-mixing structures 40 are substantially tooth-shaped with an inclined surface extending radially inward in the flow direction from the material inlet 20 to the material outlet 28.

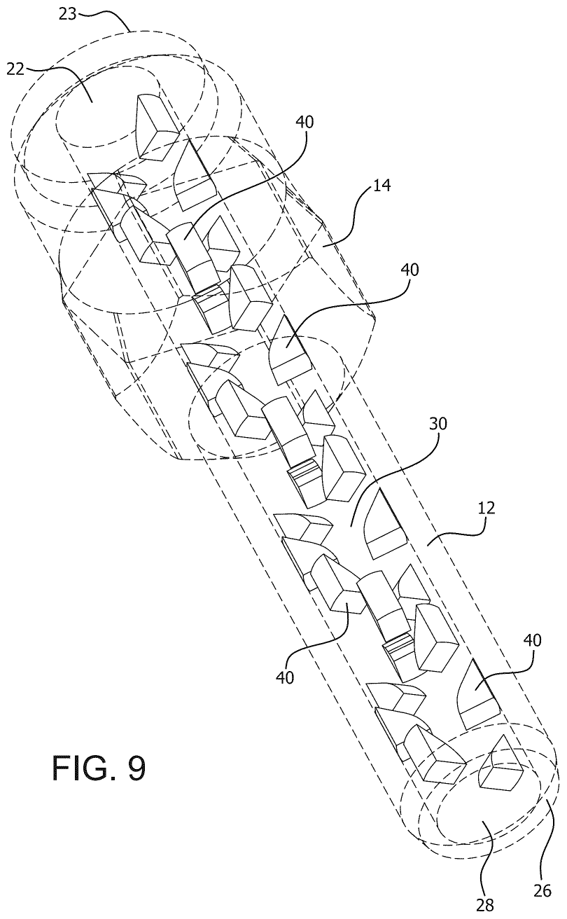

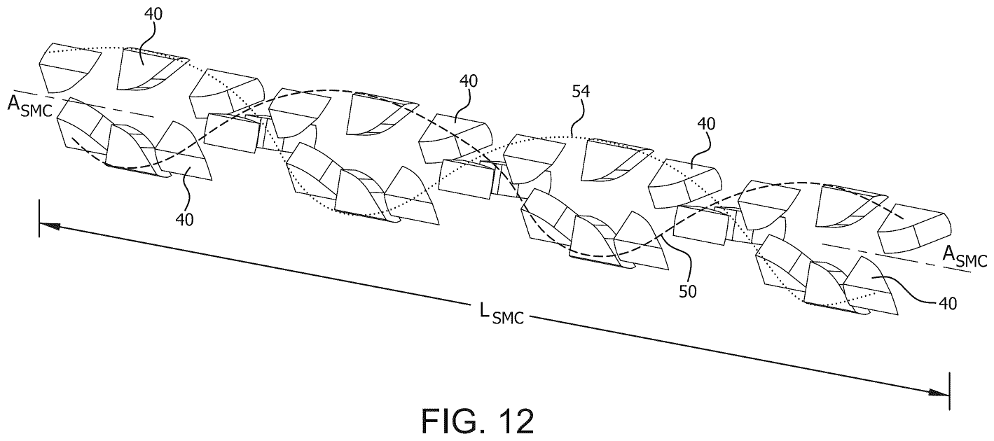

As shown in FIG. 9, the static-mixing structures 40 are radially and longitudinally distributed about and fixed to the wall 18. This distribution can be random or according to a pattern. In FIG. 12 there is shown a distribution pattern wherein the static-mixing structures 40 are distributed in a substantially double helical pattern with first helical strand 50 and second helical strand 54 wound about the longitudinal axis A_{SMC} of the static-mixing channel 30. Other patterns are possible. The function of the static-mixing structures 40 and the pattern of distribution through the static-mixing channel 30 is to ensure that additive manufacturing material and short-chopped fibers thoroughly contact the static-mixing structures 40 so as to thoroughly disperse fibers throughout the additive manufacturing material and keep the fibers dispersed as they exit the nozzle 10.

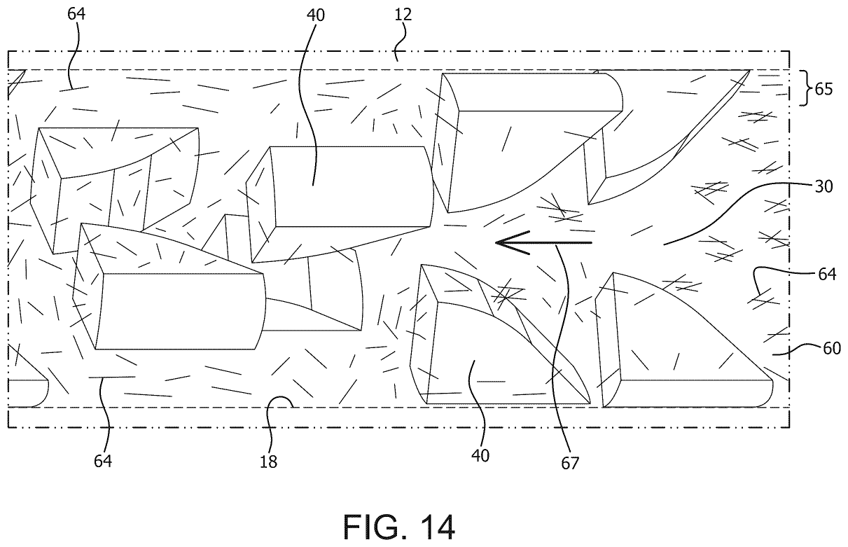

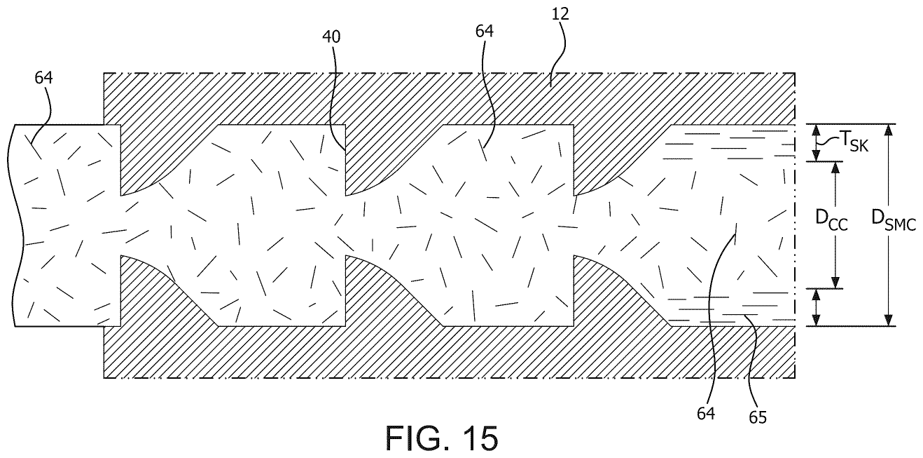

The operation of the static-mixing nozzle 10 is shown in FIGS. 14-15. The additive manufacturing material 60 is directed into the static-mixing channel 30 and short-chopped fiber 64 which are clumped together and aligned as a skin 65 at the wall 18 having a thickness T_{SK} upstream of the static-mixing structures 40, leaving a core of dimension D_{CC}. The additive manufacturing material 60 and the short-chopped fibers 64 moves through the static-mixing channel 30 in a flow direction indicated by arrow 67 and encounter and impact with the static-mixing structures 40. The clumped fibers 64 and the aligned fibers in the skin 65 are broken up by contact with the static-mixing structures 40 and exit as randomized fibers 64 that are thoroughly dispersed throughout the additive manufacturing material 60.

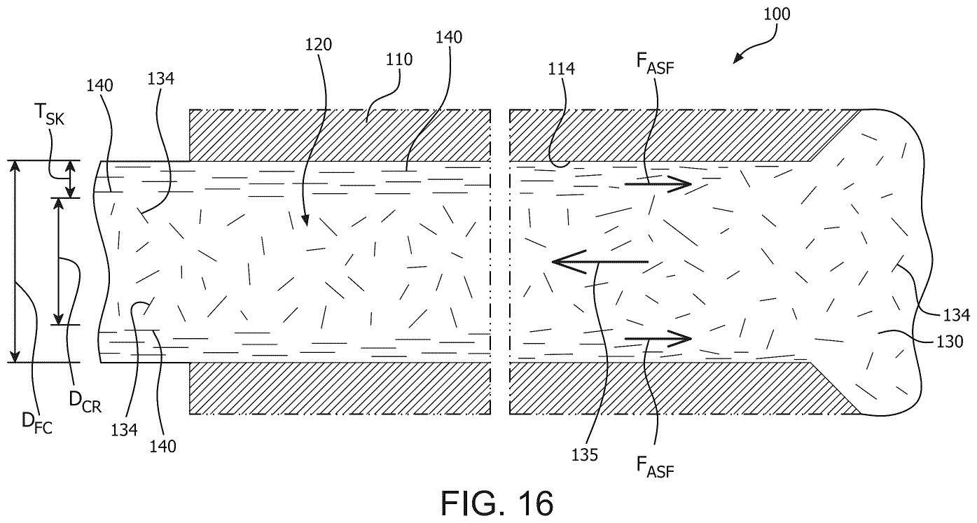

A nozzle 100 without static-mixing structures is shown in operation in FIG. 16. The nozzle 100 has a nozzle body 110 with an interior wall 114 defining a flow channel 120 having a diameter D_{FC}. Additive manufacturing material 130 including short-chopped fibers 134 moves through the flow channel 120 in the direction indicated by arrow 135, with most of the short-chopped fibers 134 being dispersed through the additive manufacturing material 130 and having a random orientation. This flow creates a frictional shear force F_{ASF} at the wall 114 which causes alignment of some of the random-orientation short-chopped fibers 134 near the wall 114 into aligned orientation short-chopped fibers 140 in a skin near the wall 114 where the skin has a thickness T_{SK}. Some of the fibers 134 remain in a core having a diameter D_{R} away from the wall 114 and retain randomized orientations.

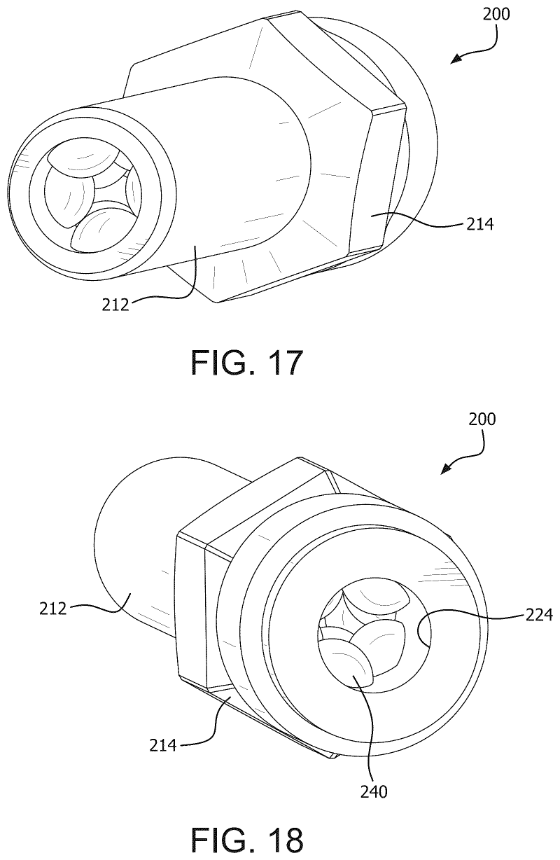

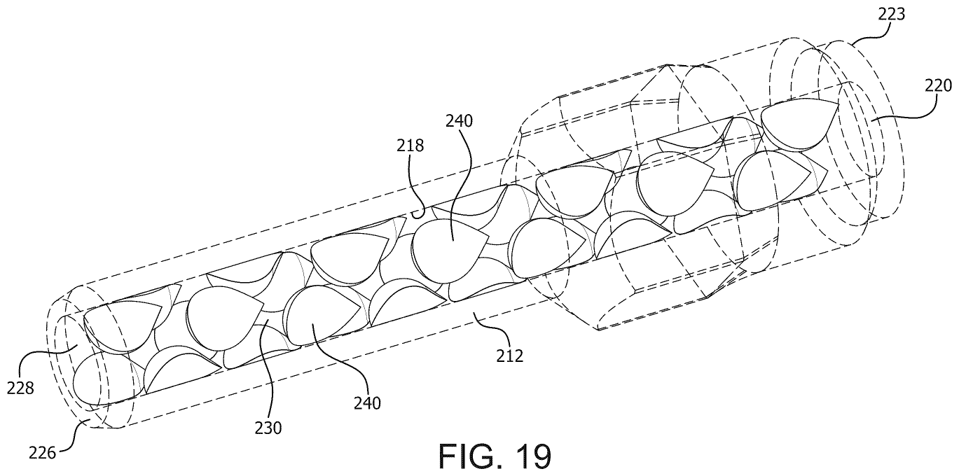

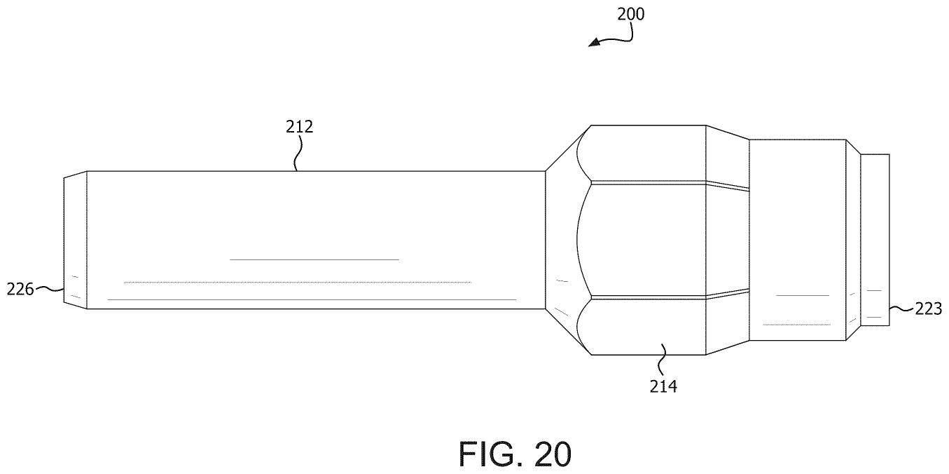

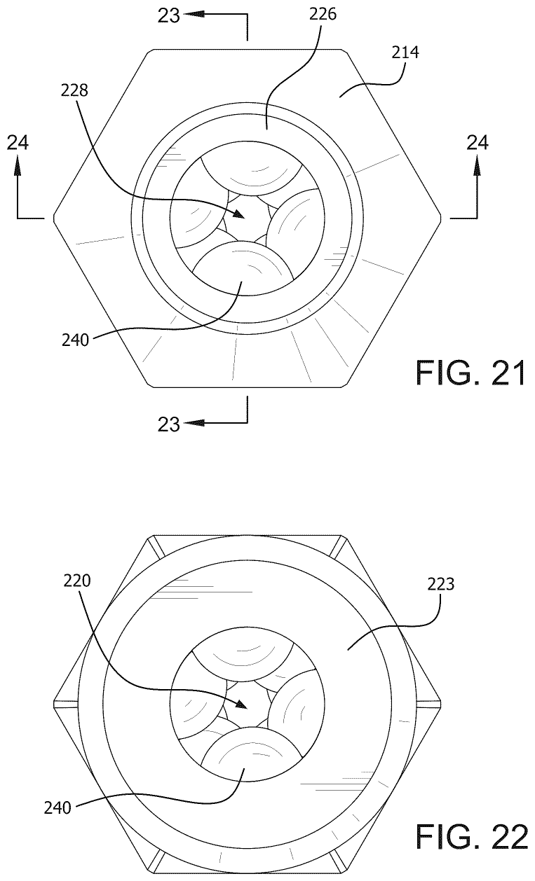

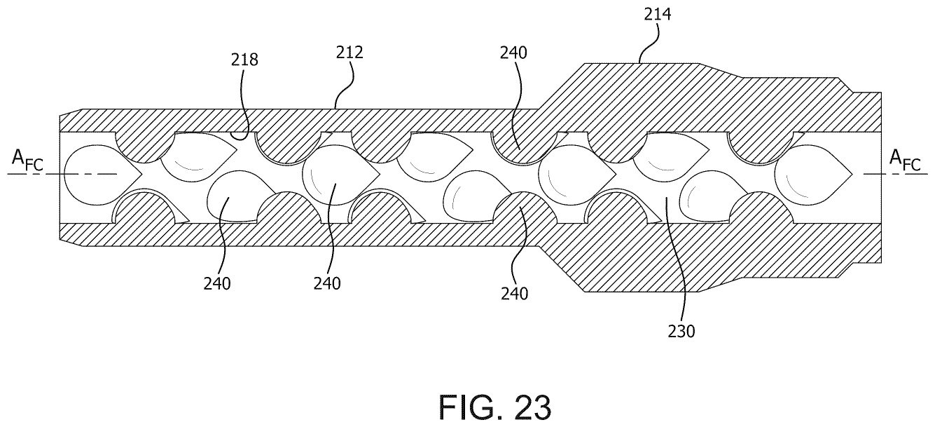

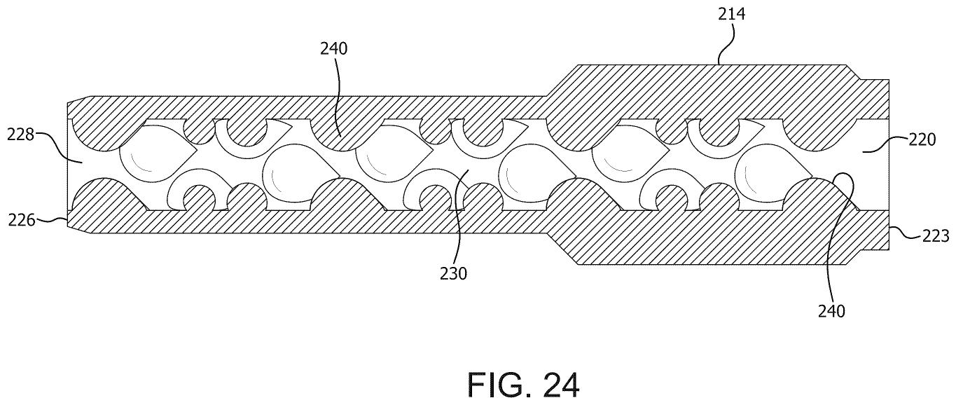

The static-mixing structures can take a variety of forms. There is a shown in FIGS. 17-24 a static-mixing nozzle 200 having a nozzle body 212 and a nozzle head 214. The static-mixing nozzle 200 has a proximal end 223 with an inlet opening 220 and a distal end 226 with an outlet opening 228. The nozzle body 212 has an interior wall 218 defined a static-mixing channel 230. Within the static-mixing channel 230 and affixed to the wall 218 are a plurality of semispherical static-mixing structures 240 which are distributed radially and longitudinally about the wall 218. Spherical shapes can be used in place of a tooth-based structure. When smooth structures are used, material can be guided across the entire mixing element. This in turn can be used to help mitigate bead indentations or gaps that may form as material exits the nozzle.

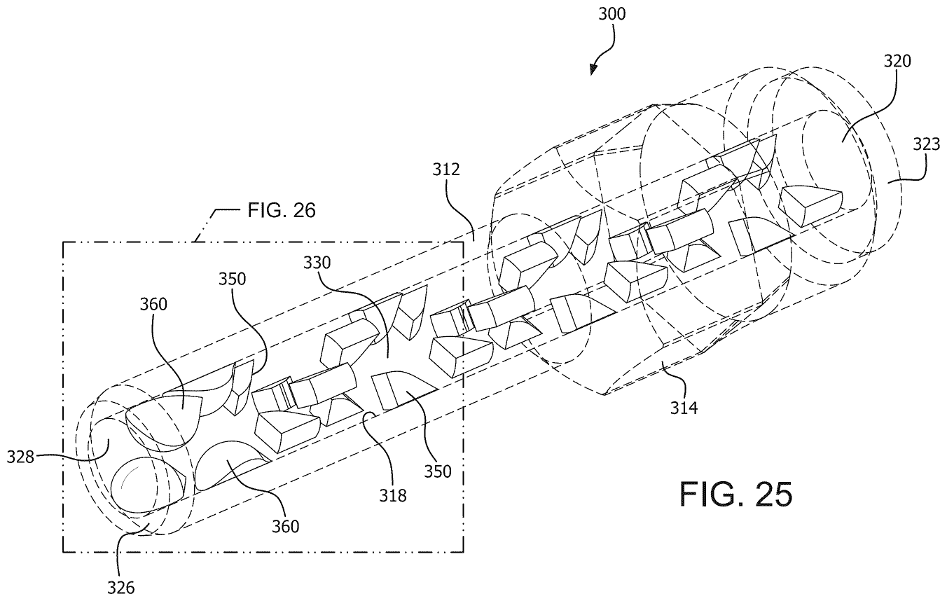

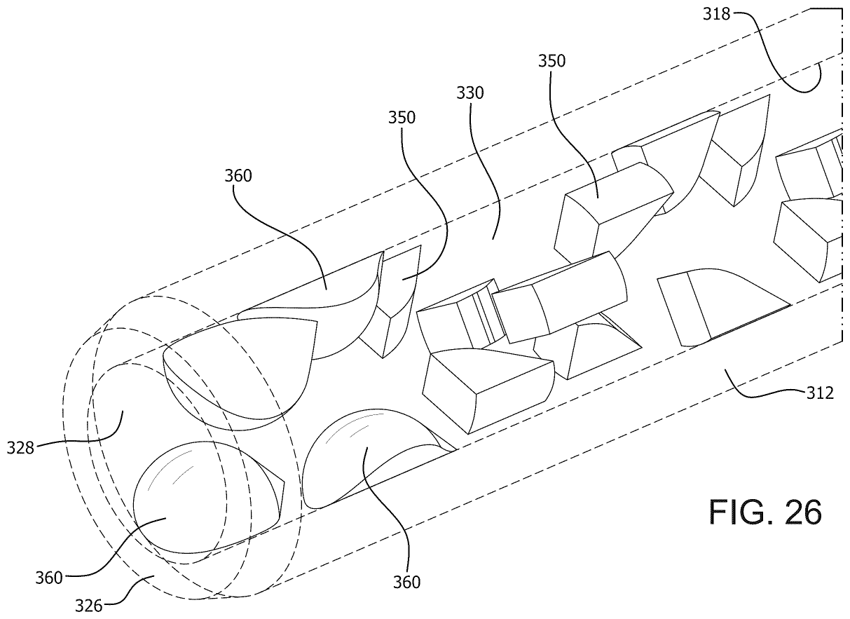

It is possible to combine differently shaped static-mixing structures. An example is shown in FIGS. 25-26, where a static-mixing nozzle 300 has a nozzle body 312 and a nozzle head 314. The nozzle 300 has a proximal end 323 having an inlet opening 320 and a distal end 326 having an outlet opening 328. The nozzle body 312 has an interior wall 318 defining a static-mixing channel 330. Within the static-mixing channel 330 and distributed radially and longitudinally about wall 318 are a plurality of toothed static-mixing structures 350 but in this embodiment also semispherical static-mixing structures 360. The semispherical spiritual static-mixing structures 360 are shown near the distal end 326, however, the toothed static-mixing structures 350 and semispherical static-mixing structures 360 could be differently numbered and differently positioned throughout the static-mixing channel 330, including both randomized or patterned distributions.

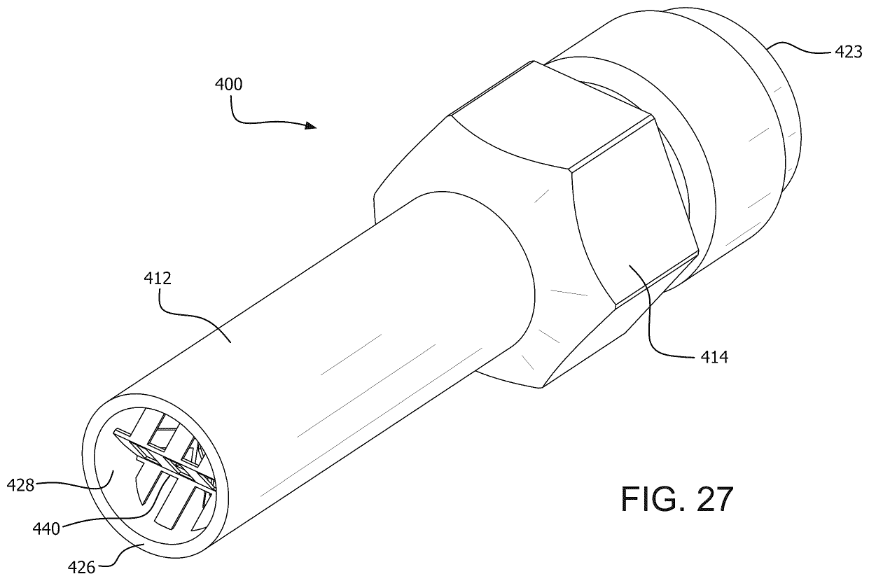

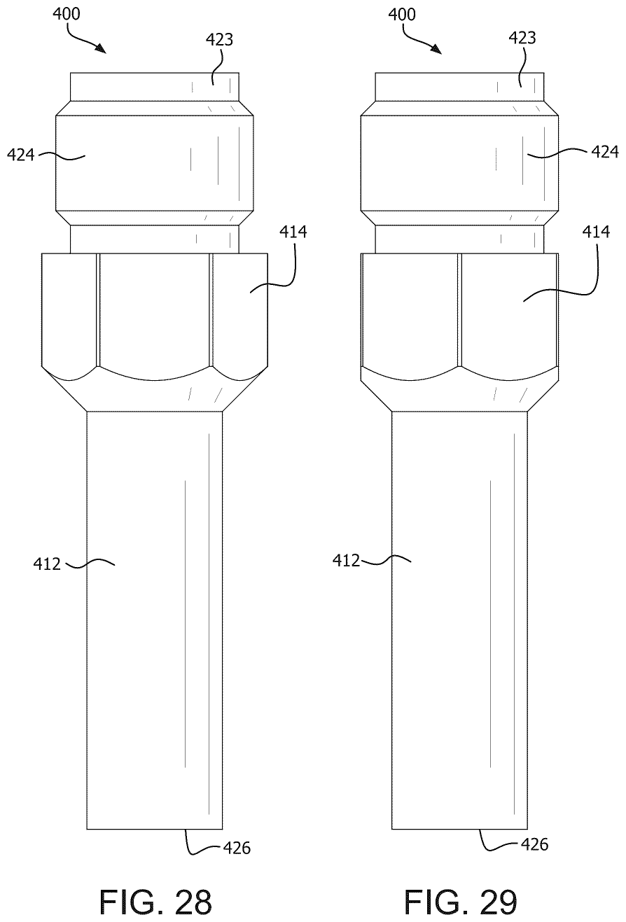

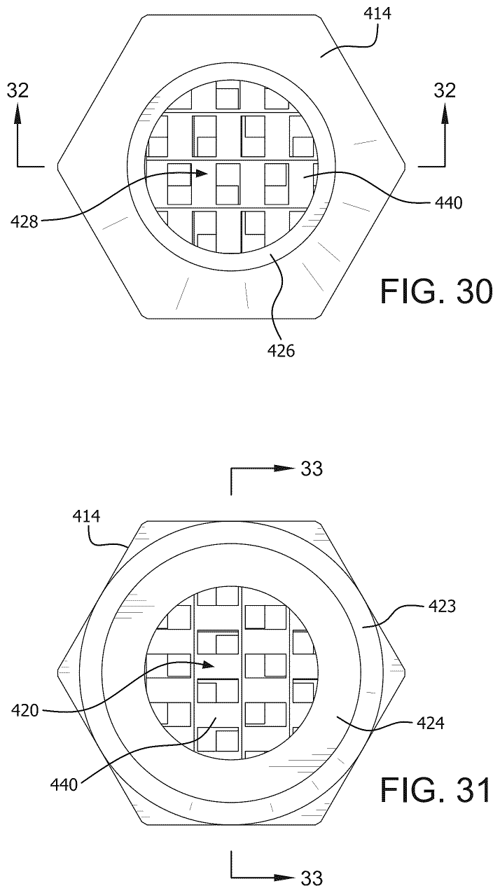

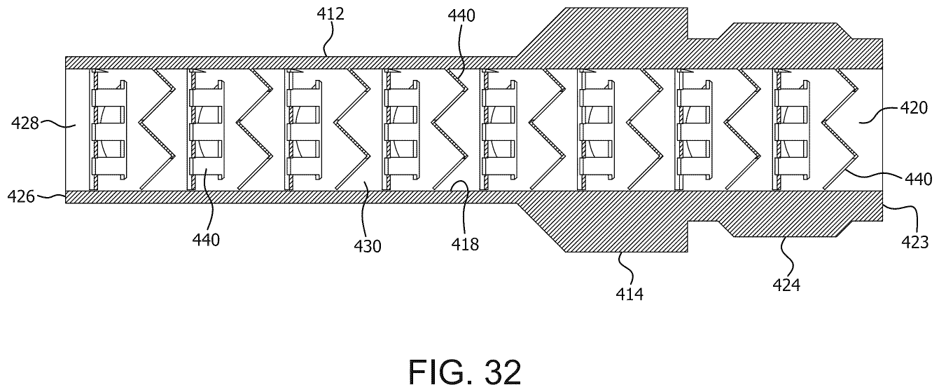

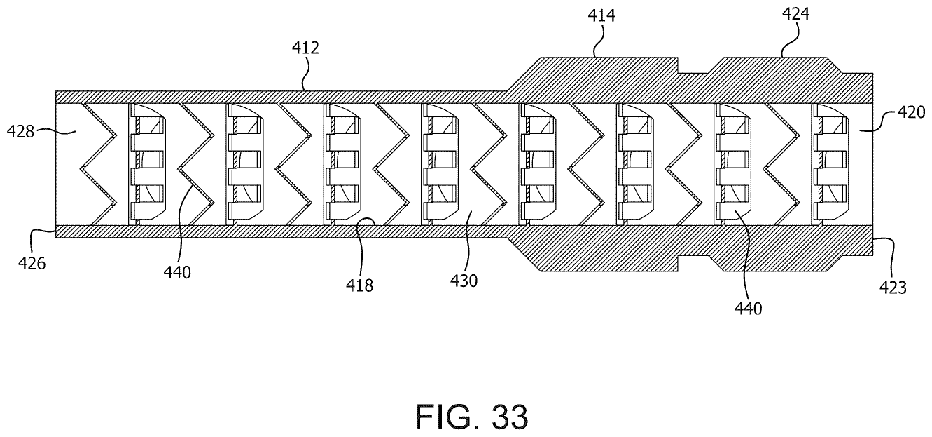

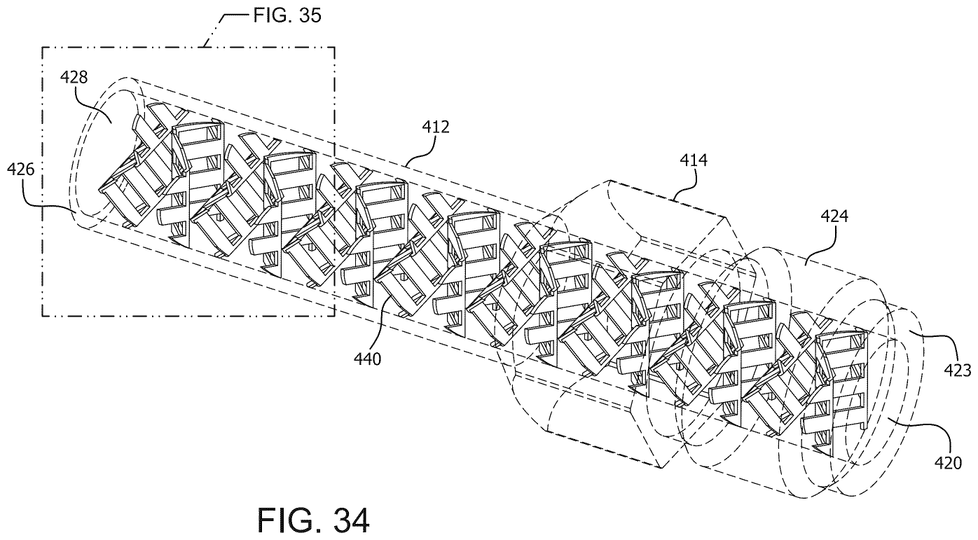

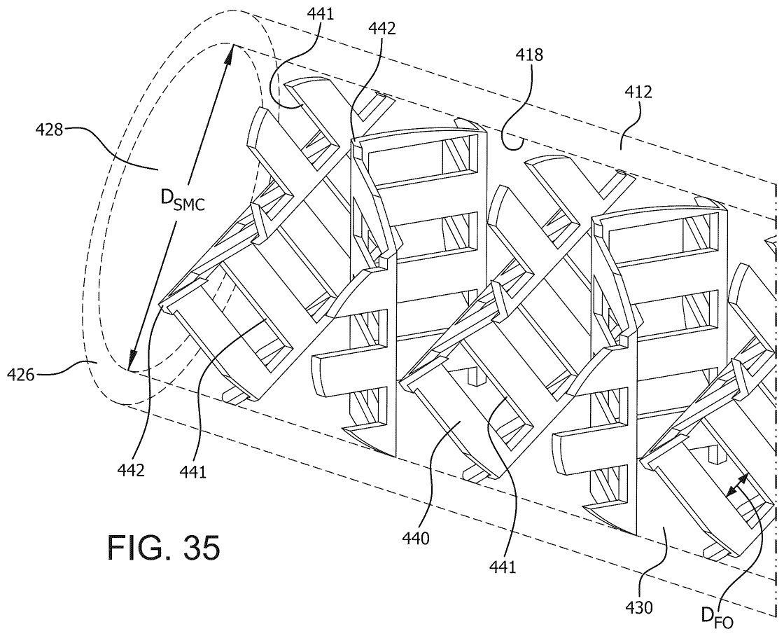

Other forms of static-mixing structures are possible. There is shown in FIGS. 27-35 a static-mixing nozzle 400 having a nozzle body 412 and nozzle head 414. The nozzle 400 has a proximal end 423 having an inlet opening 420 and a distal end 426 having an outlet opening 428. The nozzle 400 has an interior wall 418 that defines an interior static-mixing channel 430. Static-mixing structures 440 in the form of grids having flow openings 441 and folds 442 so as to differently direct some of the flow openings 441. The static-mixing grids 440 extend across the static-mixing channel 430 and are fixed to the wall 418. The static-mixing grids 440 are distributed throughout the static-mixing channel 430. Additive manufacturing material and short-chopped fibers flowing through the static-mixing channel 430 impacts the static-mixing grids 440 and must flow through the openings 441. The openings 441 are differently inclined and positioned throughout the static-mixing channel 430 such that a tortuous flow path is created to break up bundles of the short-chopped fibers and disperse these fibers throughout the additive manufacturing material. A grid type of structure with any suitable design can be utilized to create a highly turbulent flow across the entire cross-sectional area increasing the mixing effects. The nozzle 400 can also include an attachment fitting 424 for use in making threads for the nozzle.

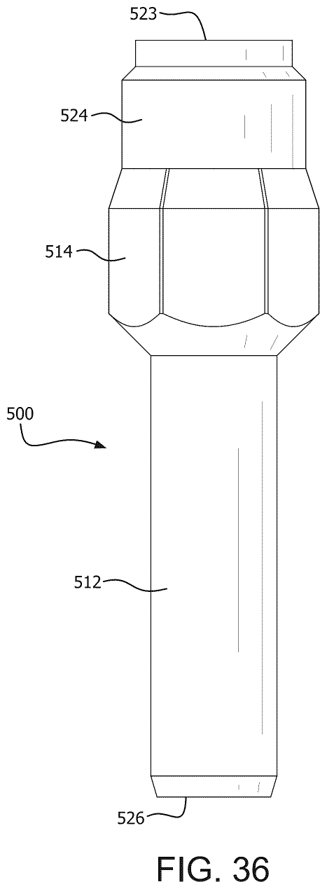

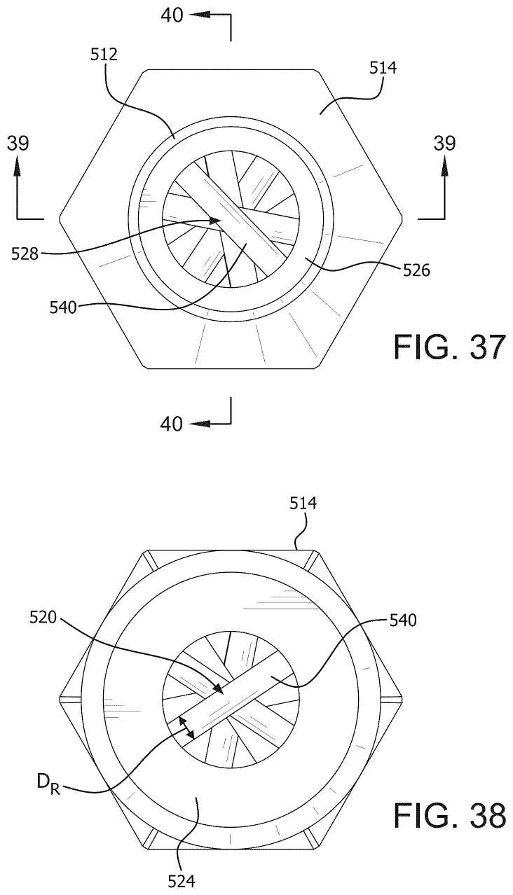

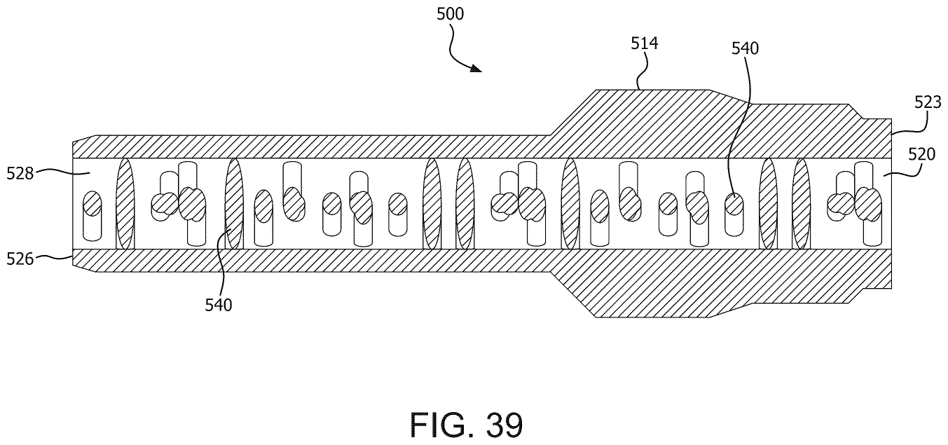

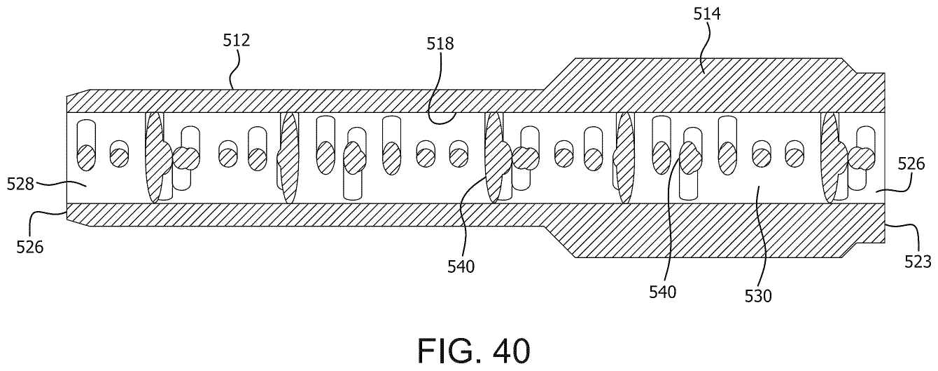

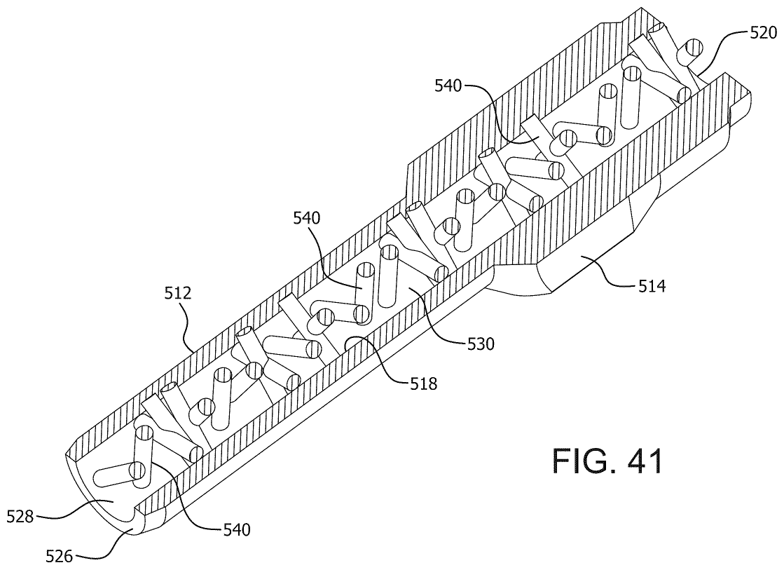

An embodiment of a static-mixing nozzle 500 incorporating static-mixing rods as static-mixing structures is shown in FIGS. 36-41. The static-mixing nozzle 500 includes a nozzle body 512 and a nozzle head 514 and a fitting 524. The nozzle 500 has a proximal end 523 with an inlet opening 520 and a distal end 526 with an outlet opening 528. The nozzle 500 has an interior wall 518 defining a static-mixing channel 530. A plurality of static-mixing rods 540 is provided in the static-mixing channel 530 and the static-mixing rods 540 can span across the static-mixing channel from one location on the wall 518 to another location on the wall 518. The additive manufacturing material and short-chopped fibers that pass through the static-mixing channel 530 impact the static-mixing rods 540 and then flow through spaces around the static-mixing rods 540. These impacts break up clumps of the short-chopped fiber and disperse the short-chopped fiber throughout the additive manufacturing material.

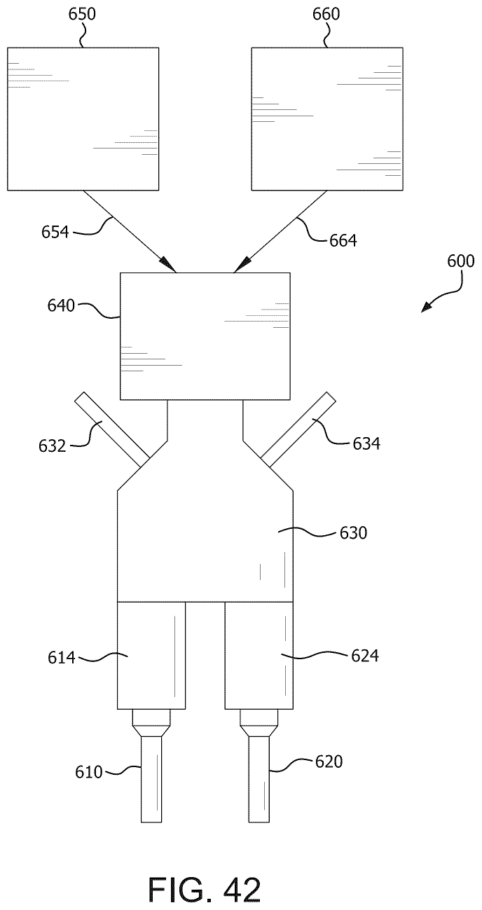

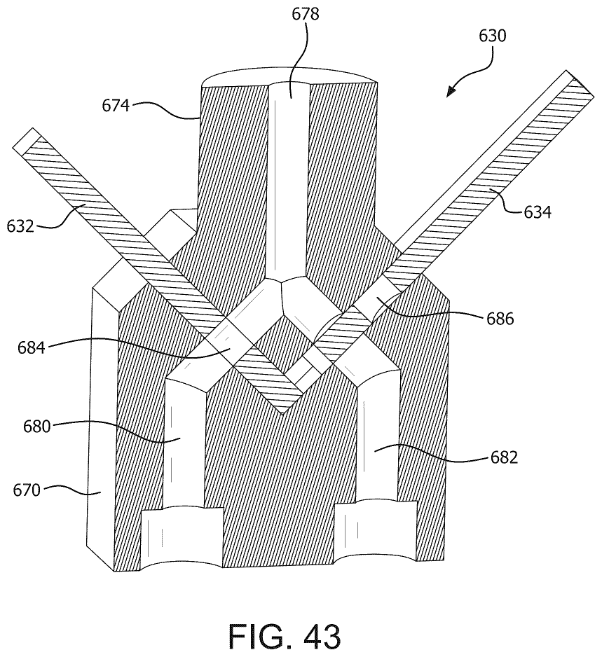

The static-mixing nozzles of the invention can be used with a variety of different extruder systems. There is shown in FIGS. 42-43 one such extruder system 600 with a static-mixing nozzle 610 and a non-mixing nozzle 620 without static-mixing structures. It is sometimes desired to switch in a single print between static-mixing and non-mixing nozzles, or even between other nozzles such as fiber-aligning nozzles. The extruder system 600 allows for switching between the static-mixing nozzle 610, and the non-mixing conventional nozzle 620, but also possibly other nozzles.

The static-mixing nozzle 610 can be connected to a barrel 614 and thereby to a valve assembly 630 with valve stems 632 and 634. The non-mixing valve 620 can be connected to a barrel 624 and thereby to the valve assembly 630. The valve assembly 630 can be in fluid connection with a mixing manifold 640. The mixing manifold 640 can receive additive manufacturing material from an additive manufacturing material source 650 through a connection 654 and can receive short-chopped fibers from a short-chopped fiber pellet source 660 and a connection 664.

The valve assembly 630 is particularly shown in FIG. 43. The valve assembly 630 has a valve body 670 and a valve neck 674. A valve inlet 678 is fluidly connected to the mixing manifold 640. The valve inlet 678 branches to a static-mixing branch 680 that communicates with the static-mixing barrel 614 and the static-mixing nozzle 610. A non-mixing branch 682 communicates with the non-mixing barrel 624 and the non-mixing nozzle 620. The static-mixing valve stem 632 has a valve opening 684 and the non-mixing valve stem 634 has a valve opening 686, which can be positioned by suitable operating structure such as solenoids to either align or block flow as desired to the static-mixing nozzle 610 or the non-mixing nozzle 620. In the configuration shown, flow will be directed to the static-mixing nozzle 610 and blocked from the non-mixing nozzle 620.

The static-mixing nozzles of the invention allow the additive manufacturing material to be continuously mixed during the extrusion process to prevent an aligned fiber skin from forming in the bead. The static-mixing structures have mixing geometries that are rigid obstacles to split and/or move the melted polymer within the nozzle. Different geometries can be used to create different levels of mixing. A portion of a conventional nozzle can be added to the end of the disclosed nozzle to reform the bead into a printable form.

A static-mixing nozzle was produced for use with the BAAM. Single-bead transitions from Material A to B and B to A were printed with the mixing nozzle at a specified screw speed. Compositional analysis tracked the progression of the material transition as a function of extrudate volume. The resulting transition curves were compared against a conventional nozzle configuration. Optical microscopy of cross-sections demonstrated that the static-mixing nozzle promoted a more uniform bead geometry as well as a more homogeneous internal structure throughout the material transition.

Adding a static-mixing nozzle to the end of the extruder enables the mixing of the melt flow of the polymer and prevent or reduce formation of a skin zone in the bead. Randomizing the fiber orientation can lead to isotropic printed structures. Static-mixing elements may differ in design and the different designs impact the level of mixing occurring, quantity of defects in the bead, and pressure observed in the system.

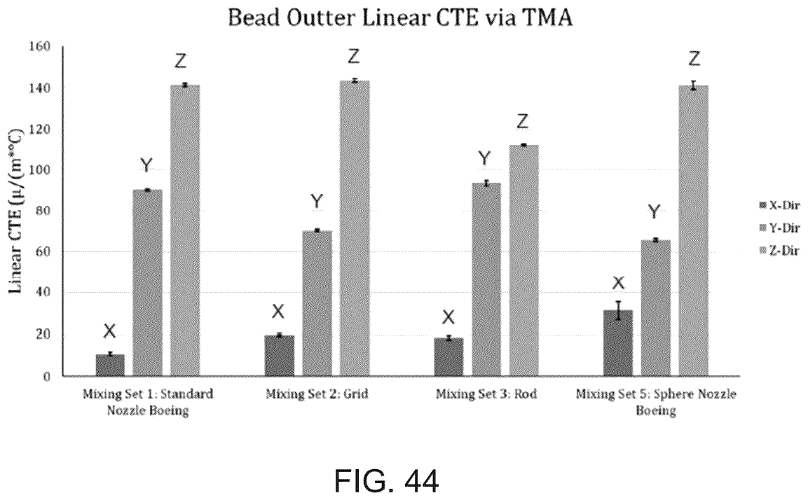

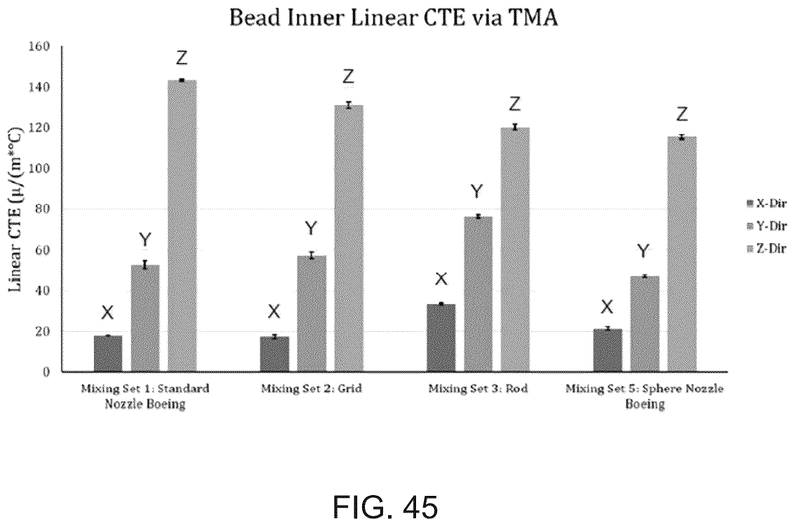

FIGS. 44 and 45 show thermomechanical analysis (TMA) results for samples printed using the static-mixing nozzles. The results are compared to samples printed using a conventional nozzle. Samples from the skin and core were also evaluated. It was found that using the rod and semispherical designs reduced the CTE in the Z direction, e.g., the layer-layer direction, for the inner bead. In the case of the rod designed nozzle, the differences in the CTE measurements in the Y and Z directions for both the outer and inner bead were reduced such that the growth and shrinkage of the part would follow similar patterns along these two directions. In addition, the X direction where fibers are typically aligned was increased by a factor of two for both the inner and outer bead by mixing the polymer inside the melt stream.

The invention can be used in systems with fiber randomization and the mixing of resins and resin dispersions with fiber randomization. A static mixing nozzle was created and implemented it in a BAAM dual-hopper printing process to improve material mixing and achieve a more homogenous internal bead structure. A conventional set of BAAM parameters and dual-hopper attachment was used to analyze the effect of a static-mixing nozzle on the material transition behavior and internal bead morphology. Transition behavior was assessed by comparing the component zones of a material transition printed with a conventional nozzle to those of one printed with a mixing nozzle. To quantify the operation of the mixing nozzle, cross-sectional analysis using optical microscopy compared samples from the blended region from each transition curve for changes in regional morphology.

Two materials provided by Techmer PM were used for all prints: HIFILL ABS 1512 3DP (ABS) and ELECTRAFIL ABS 1501 3DP (CF/ABS), a 20 wt % carbon fiber reinforced ABS. The pelletized feedstock was dried at 80° C. for at least four hours before printing using the BAAM dual-hopper configuration. Thermal conditions were kept constant using a 250° C. melt temperature, a 100° C. bed temperature, and a 255° C. nozzle temperature for each set of print conditions. Each print was deposited onto ABS build sheets that were attached to the build platform. A static-mixing nozzle utilizing static-mixing structures to periodically redirect flow with a 1.02 cm (0.40 in) diameter was used for all prints.

Bead width and height were set to 1.40 cm (0.55 in) wide and 0.51 cm (0.20 in) tall. Due to the extended length and heating attachment required for the static-mixing nozzle, the tamper typically included in BAAM prints was not used. The rotation speed of the extrusion screw was set to 300 rotations per minute (RPM), which requires a print head travel speed of 10.90 cm/s (4.29 in/s) to maintain chosen bead dimensions.

A simple rectilinear serpentine geometry was chosen for each experimental set, as shown in FIG. 46. Each print included two continuous beads in a single layer that differed only in the transition direction. Starting at Point A in FIG. 46, the dual hopper switched from using ABS pellets to drawing from the CF/ABS pellet supply. The transition from depositing ABS to CF/ABS material occurred within the first continuous bead between Points A and B. At some position prior to Point B, the transition had completed and only CF/ABS was being deposited. At Point B, extrusion momentarily stopped for the extrusion head to move to Point C. At Point C, the dual hopper switched from CF/ABS pellets to ABS pellets. Between Points C and D, the deposition material transitioned from CF/ABS back to ABS, which was completed well before Point D. At Point D, extrusion was again stopped, and the deposition nozzle moved back to Point A on the next layer. The long sides of the print geometry were 86.4 cm (34.0 in) while the short sections were 5.1 cm (2.0 in), giving a total length of 909.3 cm (358.0 in) between Points A and D.

Cross-sectional samples were extracted periodically from each print to develop a progression of the material composition. The position of a sample was determined by measuring the distance (L_{S}) from the point at which the hopper switch occurred, e.g., Points A and C in FIG. 46, and converting that to the extruded volume using Equation (1) below:

$${V}_{E} = {L}_{S} \times t \times w$$

For simplicity, the cross-section was treated as rectangular with a thickness t and a width w. The nominal bead dimensions were expected to be 14.0 mm and 5.1 mm, giving a cross-sectional area of 71.4 mm². However, optical microscopy found the typical cross-sectional area to be best represented as 58.1 mm². To better illustrate the degree of mixing that occurs during material switching, V_{E} was normalized by the free volume available in the extrusion system, V_{F}, as shown in Equation (2) below:

$${V}_{N} = \frac{{V}_{E}}{{V}_{F}}$$

Due to the complex internal geometry of the extrusion system, a CAD model was used to find the free space that would already be occupied by Material A after a hopper switch to Material B. As a result, V_{N}, the normalized volume, represents “one transition's worth” of material when V_{N}=1.

Printed transitions were initially sectioned into 7.6 cm (3.0 in) pieces and numbered sequentially to track position in the print. Individual samples for characterization were cut from the ends of these pieces using an Isomet 1000 diamond saw and were approximately 8.4 mm long. An 8.4 mm sample is a reliable representation of composition in the surrounding area. Sample locations were initially chosen based on visual inspection of color change to estimate the beginning and ending of the transitions with intent to test more frequently within and around the transition zone. After initial characterization, additional samples were selected to fill in sparse areas on the transition curve and provide a comprehensive analysis of the transition from Material A to Material B.

Samples were analyzed for carbon fiber content to determine the material composition. Ultrasonic assisted acid digestion (UAAD) was used to separate the fibers from the thermoplastic matrix. Inspired by ASTM D3171-15, UAAD was explored extensively and has proven to be an effective alternative to time-consuming carbonization-in-nitrogen and carbonization-in-air techniques. Before undergoing UAAD, samples were dried at 80° C. for at least four hours, then weighed using a RADWAG AS 220.R2 analytical balance to a 0.1 mg accuracy. Following UAAD, the solution was passed through glass microfiber filters with 1.5 μm pores to collect the separated fibers. After drying again at 80° C. for at least four hours, the fibers were again weighed and compared to the original mass of the specimen as shown in Equation (3) below:

$$Fiber wt \% = ( \frac{{M}_{i} - ( \frac{{M}_{i} - ( {M}_{c r} - {M}_{c} )}{1 - D R} )}{{M}_{i}} ) = \frac{( {M}_{c r} - {M}_{c} ) - {M}_{i} \times D R}{{M}_{i} \times ( 1 - D R )}$$

DR was the dissolution ratio representing the expected fiber loss during UAAD and filtering found in, Mᵢ was the dry mass of the printed specimen, M_{c} was the mass of pan and filter used to contain and collect the samples, and M_{cr} was the dried mass of pan and filter after fiber collection.

Changes in material transition behavior when using the dual-hopper configuration were analyzed by comparing transition curves that plot against the normalized volume of material extruded since the hopper switch was initiated. The dual-hopper configuration produces three distinct stages of material transition during printing.

The purge zone occurs immediately after switching material feedstock and is composed entirely of unmixed Material A that was already present in the barrel when the switch was made. The transition zone describes the section of the print where material composition is continually changing due to blending of the material interface during the extrusion process. Finally, the steady-state zone begins after material composition has stabilized and reached steady-state printing of Material B. Both the size of the zones and point-to-point variation of each transition curve are analyzed.

To investigate the impact of the mixing nozzle on the internal morphology of printed beads and judge the success of the design, optical images of sample cross-sections from before, within, and after the transition zone were taken. Before imaging, each specimen was polished using a six-slot AutoMet 250 autopolisher. The cross-sections were polished sequentially using 240, 320, 400, 600, and 800 SiC grit polishing pads for 1 minute each using 2 lb central force. The rotational speeds were set to 90 RPM for the platen and 60 RPM for the specimen holder in contrary rotational directions. A 1200 grit SiC paper was then used for 15 minutes with the same conditions. Finally, the polish was finished by using a 6 μm diamond suspension, a 3 μm diamond suspension, and colloidal silica for 20, 10, and 25 minutes respectively. These steps utilized a complementary rotation with both speeds set to 60 RPM. The sample surfaces were cleaned of debris using a sonicator filled with deionized water. Optical images were taken using a Keyonce VHX-5000 digital microscope and compared to cross-sections from prints that used a typical BAAM nozzle.

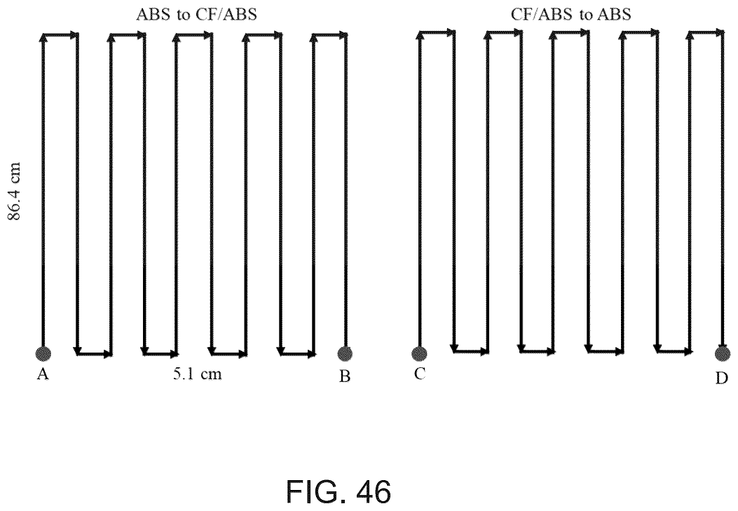

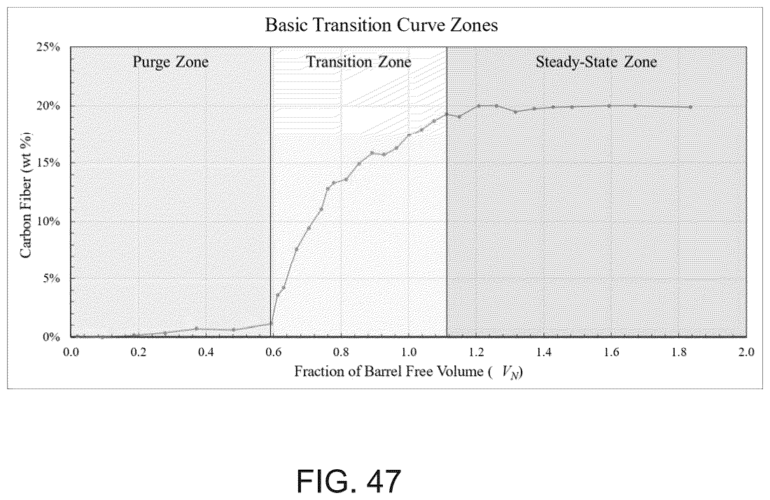

Using the measured carbon fiber content, material composition was tracked as percent CF/ABS in both transition directions for all transition curves. FIG. 47 shows a transition curve in each direction for a print using the static mixing nozzle and for another using a conventional nozzle with otherwise identical settings.

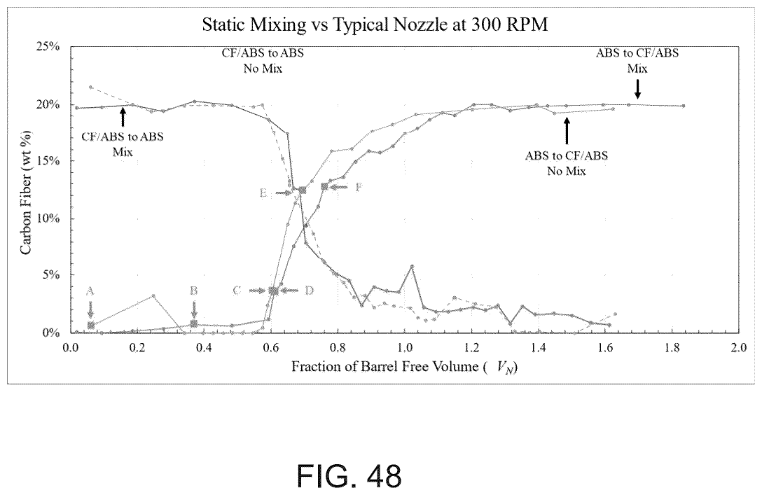

As stated previously, the purge zone ends and transition zone begins with a sudden change in material composition, but the end point of the transition zone and beginning of steady-state Material B can be difficult to identify, especially in the CF/ABS to ABS print direction. Per previous work, the CF/ABS feedstock can exhibit carbon fiber values as low as 19 wt %, so the steady-state zone for ABS to CF/ABS transitions was considered to begin where one data point and the following are both at or above 19 wt % carbon fiber. For the CF/ABS to ABS direction, steady-state Material B was determined on a case-by-case basis while considering the relative noise due to residual carbon fibers becoming stuck in the complex internal geometry. When comparing transition curves for the mixing nozzle to the conventional nozzle in FIG. 48, the ABS to CF/ABS direction demonstrated a slight delay in initiation of the transition zone and a longer transition zone overall. As would be expected, this led to a shorter overall transition to Material B for the conventional nozzle. For the CF/ABS to ABS direction, the transition zone began earlier in the mixing nozzle, but a longer transition zone resulted in a near equal overall transition volume for both the CF/ABS to ABS transition curves.

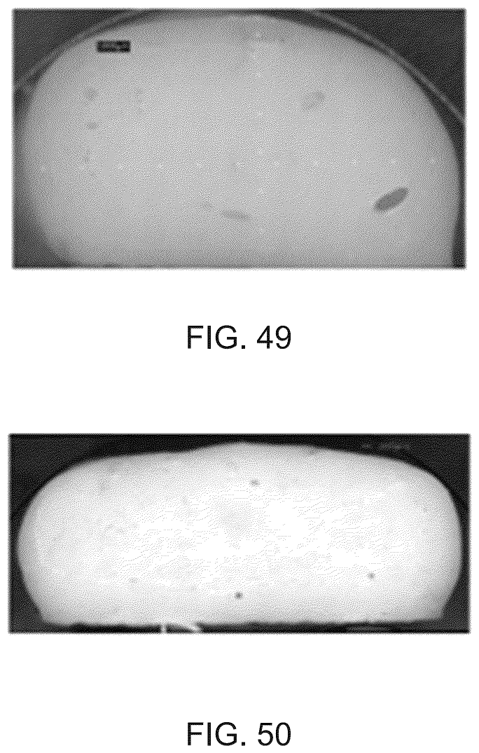

The primary aim of introducing a static mixing nozzle was to improve the mixing of materials within the transition zone and eliminate discrete regions of Material A and B. FIGS. 49-54 shows cross-sections from the six orange, square data points labelled A through F in FIG. 48 to match.

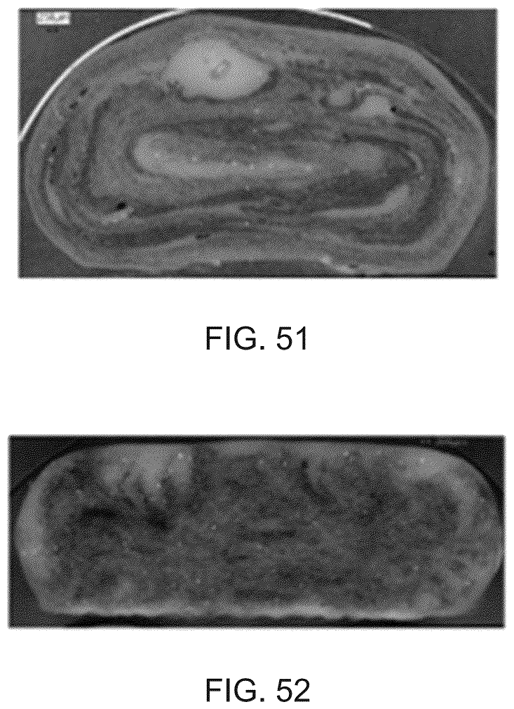

The arrangement places conventional nozzle samples on the top row and mixing nozzle samples on the bottom row with similar composition arranged vertically. Initial observations reveal a noticeable difference in bead shape between mixing and conventional nozzle samples. Furthermore, there is a distinct difference in the morphology of the transition samples when comparing FIG. 51 to FIG. 52 and FIG. 53 to FIG. 54. In both cases, the conventional nozzle cross-sections exhibit a distinct regional morphology where there are clear pockets of both ABS and CF/ABS distributed throughout the bead. The mixing nozzle specimens do not display this regional behavior, indicating an increase in internal mixing that created a more homogenous internal bead structure, as desired. As shown, this was true at differing fiber contents and was consistent throughout the printed transitions, which aligned with the stated goal of improved material mixing when using the static-mixing nozzle.

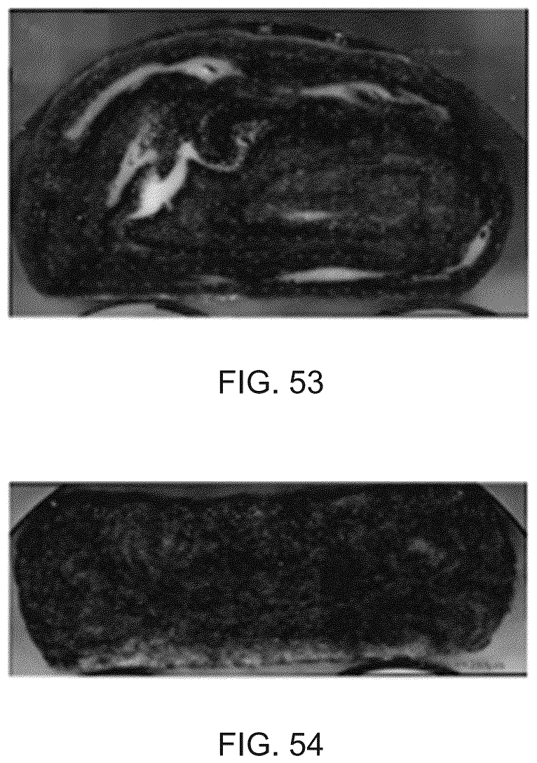

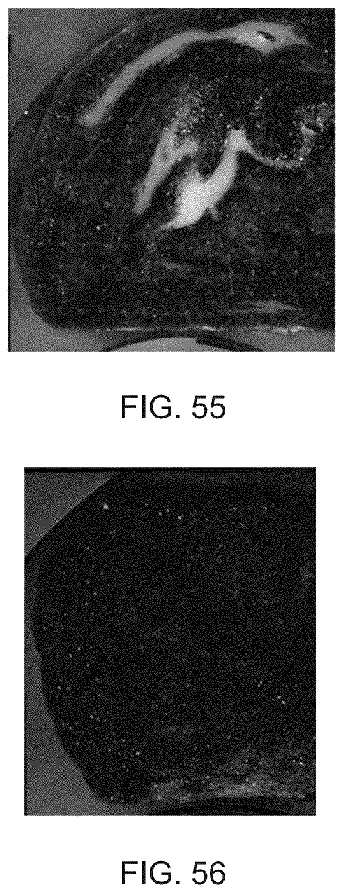

The improvements in homogeneity are highlighted in FIGS. 55-56, which compare the same location on the cross-sections in FIG. 53 and FIG. 54.

Here, the conventional nozzle sample in FIG. 55 exhibits CF/ABS-rich, neat abs, and partially mixed regions all within this small section of the printed bead. In stark contrast, the mixing sample in FIG. 56 maintains a consistent distribution of material throughout with only the bottom of the bead having any indication of a discrete neat ABS region. In addition, there is a distinctive pattern or swirl visible in the conventional nozzle left as an artifact of the extrusion process that is not readily apparent in the mixing nozzle sample. As a result, mixing nozzle sample displays a much more homogenous morphology.

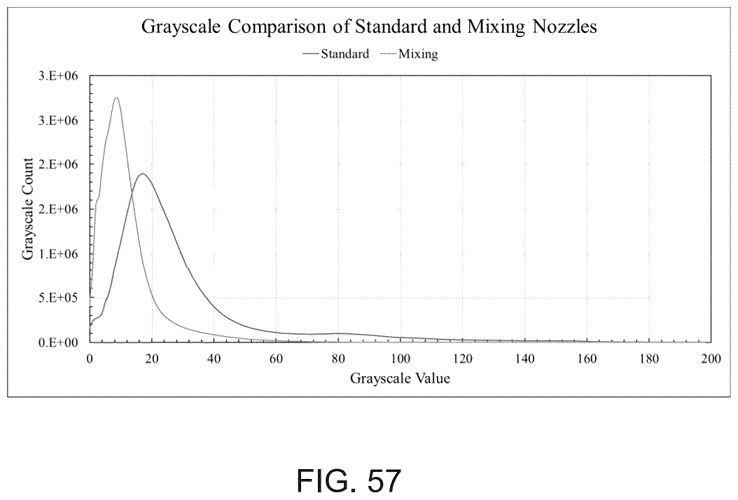

To better quantify the improved mixing seen when using the mixing nozzle, the two cross sections shown in FIGS. 55-56 were analyzed using an image processor. After converting the images to an 8-bit grayscale image, a simple pixel count and distribution of values was recorded. The results are presented in FIG. 57.

The average grayscale value was 13.1 with a standard deviation of 14.6 for the mixing nozzle while the conventional nozzle had an average grayscale value of 29.6 with a deviation of 25.6. As is seen in FIG. 57, this shows a heavy, narrow weighting toward black for the mixing nozzle while there are many more instances of lighter counts causing a higher deviation for the conventional nozzle. This results in a “tail” leading into the white values of the grayscale, which matches the visual observations of increased instances of ABS and unmixed material within the cross-sections.

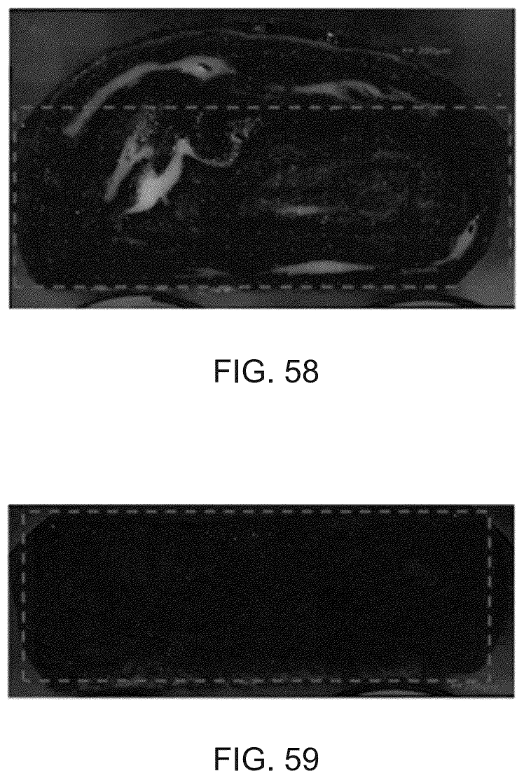

In addition to improving mixing of the constituent materials, the mixing nozzle also impacted the uniformity and shape of the printed bead. FIGS. 58-59 compare the input dimensions provided to the BAAM, represented as a dashed line, to both the conventional (FIG. 58) and mixing (FIG. 59) nozzle cross-sections.

As can be seen, the conventional nozzle produces a much more elliptical bead than the mixing nozzle, which results in a near-rectangular cross-section well-suited to the volumetric treatments necessary for accurately calculating and forming the transition curves. Since the static mixing nozzle inhibits material flow with a complex internal geometry, an increase in back-pressure is to be expected. The increased back pressure would then counteract the drag flow, resulting in an overall decrease in material flow through the nozzle. In addition, the deposition rate remains constant. Therefore, the change in bead geometry and reduction in cross-sectional area matches expectations of a reduced flow deposited at the same rate as a with conventional nozzle. This difference is highlighted in Section 2.3 when discussing the cross-sectional area utilized to calculate the normalized volume for the static mixing nozzle transition curves in FIG. 48.

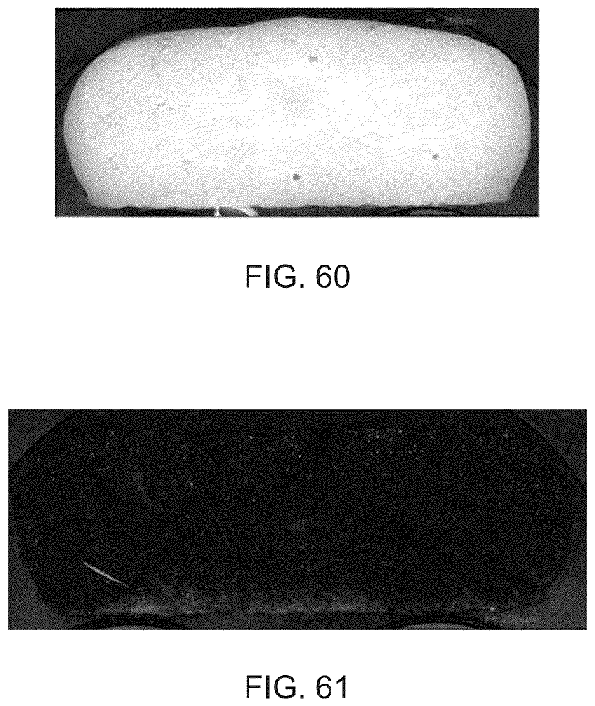

While the inclusion of the static mixing nozzle improved mixing and dispersion of the component materials, there were also instances of porosity observed. As shown in FIGS. 60-61, optical imaging showed a significant amount of porosity in samples from both the purge and transition zones. However, FIG. 60 exhibits larger pores with fewer instances whereas FIG. 61 had a greater number of pores but with a smaller size. Further imaging indicated that pore size continued to decrease as fiber content increased.

A static-mixing nozzle was included in the BAAM dual-hopper material transition process to improve mixing of the constituent materials. The general transition behavior resembled that previously observed using a conventional nozzle design with the mixing nozzle resulting in a slightly longer overall transition and increased instances of residual fibers. The recurring presence of carbon-fiber rich specimens indicates that the complex geometry of the mixing nozzle was retaining or trapping fibers that were later freed by the continuously flowing polymer melt. This effect was primarily seen in the CF/ABS to ABS transition direction, but a stair-stepping effect seen in the transition region of the ABS to CF/ABS transition curves could also be a possible artifact of the mixing nozzle. Optical microscopy demonstrated that the mixing nozzle successfully produced a more homogenous morphology than the conventional nozzle design as desired. This was quantified by comparing grayscale distributions, which showed a significant weighting toward white (ABS) and higher deviation in the conventional nozzle compared to the mixing nozzle.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. An additive manufacturing system, comprising:
an extruder comprising a static-mixing nozzle having a static-mixing channel defined by a channel wall, the static-mixing channel having a diameter D_{SMC} and a longitudinal center axis having length L_{SMC}, an input end and an opposing output end, the static-mixing channel being fluidly coupled at the input end to feeding means through which additive manufacturing material and short-chopped fiber are to be provided to the extruder, the static-mixing nozzle comprising static-mixing structures distributed inside the static-mixing channel and extending radially inward from the channel wall, the mixing structures having a length L_{MS}, a width W_{MS} and a radial dimension R_{MS}, and being longitudinally distributed and radially staggered over a portion of the length of L_{SMC} of the static-mixing channel; and
wherein the static-mixing nozzle is configured to guide a bead of the additive manufacturing material and short-chopped fiber from the input end to the output end of the static-mixing channel, mix the short-chopped fiber with the additive manufacturing material to randomize orientations of the short-chopped fiber within the additive manufacturing material, and extrude a bead of mixed additive manufacturing material and short-chopped fiber through the output end, causing the extruded bead to be deposited as part of a layer of an object being formed by the additive manufacturing system.

2. The system of claim 1, wherein the static-mixing structures extend from and are connected to one position on the channel wall to another position on the channel wall.

3. The system of claim 2, wherein the static-mixing structures are rods, and spaces between the rods defining flow openings for the additive manufacturing material and the short-chopped fiber.

4. The system of claim 3, wherein the diameter of the rods D_{R} is from 1 to 30% D_{FC}.

5. The system of claim 2, wherein the static-mixing structures are grids having planar portions and a plurality of flow openings.

6. The system of claim 5, wherein the diameter of the flow openings D_{FO} is from 1 to 50% of D_{SMC}.

7. The system of claim 2, wherein the static-mixing structures are connected from an upstream position on the channel wall to a downstream position of the channel wall.

8. The system of claim 1, wherein the bead has a skin comprising aligned short chop fibers, the skin having a radial thickness T_{SK}, and the radial dimension of the static-mixing structures R_{MS} is a least as great as the skin thickness T_{SK}.

9. The system of claim 6, wherein the radial dimension of the static-mixing structures R_{MS} is less than ½ D_{SMC}, and the circumferential width is less than ¼ of a circumference of the static-mixing channel.

10. The system of claim 7, wherein the diameter of a central core D_{CC} is defined by D_{SMC}−2 R_{MS}, and D_{CC} is from 10% to 50% of DFC.

11. The system of claim 6, wherein the radial dimension R_{MS} of the mixing structures is greater than 0.2 T_{SK}.

12. The system of claim 6, wherein the static-mixing structures are semispherical in shape.

13. The system of claim 6, wherein the static-mixing structures are tooth shaped.

14. The system of claim 1, wherein the static-mixing structures are longitudinally staggered and radially distributed in a helical pattern.

15. The system of claim 1, wherein the static-mixing structures are longitudinally staggered and radially distributed in a double helical pattern.

16. The system of claim 1, wherein the short-chopped fibers have a length of from 0.1 mm to 12 mm.

17. The system of claim 1, wherein the short-chopped fiber comprises at least one selected from the group consisting of C fiber, glass fiber, or bio fiber.

18. The system of claim 1, wherein the short-chopped fiber has an aspect ratio
$$S = \frac{L}{d}$$
less than 100, L being the fiber's length and d being the fiber's diameter.

19. The system of claim 1, wherein the additive manufacturing material is a thermoplastic polymer.

20. The system of claim 1, wherein the static-mixing channel is tubular.

21. A static mixing nozzle for an additive manufacturing system;
comprising:
a static-mixing channel defined by a channel wall, the static-mixing channel having a diameter D_{SMC}, and a longitudinal center axis having length L_{SMC}, an input end and an opposing output end, the static-mixing channel being fluidly coupled at the input end to feeding means through which additive manufacturing material and short-chopped fiber are to be provided to the extruder, the static-mixing nozzle comprising static-mixing structures distributed inside the static-mixing channel and extending radially inward from the channel wall, the static-mixing structures having a radial length L_{MS}, a width W_{MS} and a radial dimension R_{MS}, being longitudinally distributed and radially staggered over a portion of the length of L_{SMC} of the static-mixing channel; and
wherein the static-mixing nozzle is configured to guide a bead of the provided thermoplastic resin and short-chopped fiber from the input end to the output end of the static-mixing channel, mix the short-chopped fiber with the thermoplastic resin to randomize orientations of the short-chopped fiber within the thermoplastic resin, and extrude a bead of mixed thermoplastic resin and short-chopped fiber through the output end, causing the extruded bead to be deposited as part of a layer of an object being formed by the additive manufacturing system.

22. A method for additive manufacturing with additive manufacturing material and short-chopped fibers, comprising the steps of:
providing an extruder comprising a static-mixing nozzle having a static-mixing channel defined by a channel wall, the static-mixing channel having a diameter D_{SMC}, and a longitudinal center axis having length L_{SMC}, an input end and an opposing output end, the static-mixing channel being fluidly coupled at the input end to feeding means through which the additive manufacturing material and short-chopped fiber are to be provided to the extruder, the static-mixing nozzle comprising mixing structures distributed inside the static-mixing channel and extending radially inward from the channel wall, the static-mixing structures having a radial length L_{MS}, a width W_{MS} and a radial dimension R_{MS}, being longitudinally distributed and radially staggered over a portion of the length of L_{SMC} of the static-mixing channel;
guiding a bead of the provided additive manufacturing material and short-chopped fiber from the input end to the output end of the static-mixing channel, and mixing the short-chopped fiber with the additive manufacturing material by contact with the static-mixing structures to randomize orientations of the short-chopped fiber within the additive manufacturing material; and,
extruding a bead of mixed additive manufacturing material and short-chopped fiber through the output end, causing the extruded bead to be deposited as part of a layer of an object being formed by the additive manufacturing system.

23. A method of making a nozzle for the additive manufacturing of polymer and composite materials with short-chopped fibers, comprising the steps of:
providing a nozzle having a central channel;
flowing an additive manufacturing material and short-chopped fiber through the nozzle and drawing an extruded bead of the additive manufacturing material and short-chopped fiber, the bead having a core of additive manufacturing material and randomized short-chopped fibers, the core having a diameter D_{CC}, and a skin comprising aligned short chop fibers, the skin having a radial thickness T_{SK};
measuring the T_{SK};
constructing a static-mixing nozzle having a static-mixing channel defined by a channel wall, the static-mixing channel having a diameter D_{SMC}, a length L_{SMC}, a longitudinal center axis A_{SMC} an input end and an opposing output end, the static-mixing channel being fluidly coupled at the input end to feeding means through which the additive manufacturing material and short-chopped fiber are to be provided to the extruder, the static-mixing nozzle comprising static-mixing structures distributed inside the static-mixing channel and extending radially inward from the channel wall, the mixing structures having a radial length L_{MS}, a width W_{MS} and a radial dimension R_{MS}, being longitudinally distributed and radially staggered over a portion of the length L_{SMC} of the static-mixing channel, wherein the radial dimension of the static-mixing structures R_{MS} is a least 0.2 T_{SK}.
